(19) United States
(12) Patent Application Publication
(10) Pub. No.: US 2011/0169880 A1
(43) Pub. Date: Jul. 14, 2011

(54) LIQUID CRYSTAL DISPLAY DEVICE AND METHOD FOR DRIVING LIQUID CRYSTAL DISPLAY DEVICE

(76) Inventors: Tomoo Furukawa, Osaka (JP); Kazuyoshi Fujioka, Osaka (JP)

(21) Appl. No.: 13/119,010

(22) PCT Filed: Jun. 17, 2009
(86) PCT No.: PCT/JP2009/061043

§ 371 Date: Mar. 15, 2011

(30) Foreign Application Priority Data
Sep. 18, 2008 (JP) 2008239830

(51) Int. Cl. G09G 5/10; G09G 3/36

(52) U.S. Cl. 345/690; 345/89

(57) ABSTRACT

A liquid crystal display device (10) in accordance with the present invention includes a display controller (14) (display drive section) for (i) dividing dots into a plurality of units each of which includes a predetermined number of dots and (ii) supplying pieces of gray scale data, into which a piece of input gray scale data is converted and which differ from location to location, to the respective dots in each of the plurality of units. The display controller (14) carries out the conversion so that a spatial average of the pieces of the gray scale data supplied to the respective dots in each of the plurality of units causes a gray scale display based on the piece of the input gray scale data. The display controller (14) includes a location information detection section (31), an input data conversion section (33) (gray scale data conversion section), and the like.

### TECHNICAL FIELD

The present invention relates to a liquid crystal display device in which a display is carried out by a so-called area-division driving, and a method for driving a liquid crystal display device.

### BACKGROUND ART

A liquid crystal display device is a flat display device that has excellent advantages that it has high definition, is thin, is light, consumes low electrical power, and the like. In recent years, a market scale of such a liquid crystal display device has rapidly expanded because the liquid crystal display device has been improved in its display performance, manufacturing capacity, and price competitiveness against other display devices.

A twisted nematic (TN) liquid crystal display device, which has conventionally been used generally, includes substrates that have been subjected to an alignment treatment such that longitudinal axes of respective liquid crystal molecules each having positive dielectric anisotropy are (i) aligned in substantially parallel to surfaces of the substrates and (ii) twisted along a thickness direction of a liquid crystal layer so that longitudinal axes of respective liquid crystal molecules near an upper one of the substrates are at approximately 90 degrees with longitudinal axes of respective liquid crystal molecules near a lower one of the substrates. A voltage applied to the liquid crystal layer causes the liquid crystal molecules to be oriented in parallel to an electric field, thereby canceling twisted alignment. The TN liquid crystal display device controls an amount of transmitted light by utilizing a change of optical rotation, which is caused by changes of orientations of the liquid crystal molecules in response to the voltage application.

The TN liquid crystal display device is excellent in productivity because of its wide production margin. Note, however, that such a TN liquid crystal display device causes a problem in terms of a display performance, particularly in terms of a viewing angle characteristic. Specifically, when a display surface of the TN liquid crystal display device is viewed from an oblique direction, a contrast ratio of the display is significantly low. More specifically, while a plurality of gray scale levels from black to white of an image are clear when the image is viewed from a front direction, luminance differences among the plurality of gray scale levels of the image are significantly unclear when the image is viewed from an oblique direction. Further, is has also been a problem that a portion that looks darker when viewed from a front direction looks brighter when viewed from an oblique direction, because gray scales of the display are reversed (such a phenomenon is a so-called gray scale reversal).

Recently, there have been developed liquid crystal display devices each having a more excellent viewing angle characteristic than that of the TN liquid crystal display device. Examples of such liquid crystal display devices encompass: an IPS (in-plane switching) liquid crystal display device, an MVA (multidomain vertical alignment) liquid crystal display device, a CPA (continuous pinwheel alignment) liquid crystal display device, and the like.

Each of such liquid crystal display devices of a new mode (wide viewing angle mode) has overcome the foregoing specific problem in terms of the viewing angle characteristic. That is, such liquid crystal display devices do not cause problems such as a significant reduction in the display contrast ratio, reversal of the display gray scale, and the like, even when the display surface is viewed from an oblique direction.

However, as the liquid crystal display device has been improved in its display quality, a new problem of the viewing angle characteristic has become obvious today. That is, a gamma characteristic obtained when viewed from a front direction and a gamma characteristic obtained when viewed from an oblique direction are different, i.e., a problem (e.g., excess brightness) occurs because of viewing angle dependence of the gamma characteristic. Note here that the gamma characteristic is gray scale level dependence of the display luminance. If a gamma characteristic obtained when viewed from a front direction is different from a gamma characteristic obtained when viewed from an oblique direction, then gray scales of the display look differently depending on the direction from which the display is viewed. This is a problem particularly in a case where an image such as a photograph is displayed or in a case where TV broadcasting or the like is displayed.

Such a problem of the viewing angle dependence of the gamma characteristic is more significant in the MVA and the CPA liquid crystal display devices than in the IPS liquid crystal display device. On the other hand, the IPS liquid crystal display device has a problem that it is difficult to manufacture, with good productivity, a panel that has a high contrast ratio when the panel is viewed from a front direction, as compared with the MVA and the CPA liquid crystal display devices. Under such circumstances, it is desired that the viewing angle dependence of the gamma characteristic be improved particularly in the MVA and the CPA liquid crystal display devices.

Patent Literature 1 proposes a multi-dot driving as a method for improving the viewing angle dependence of the gamma characteristic.

The multi-dot driving is a technique in which each display dot includes two or more subdots having different luminances, thereby improving the viewing angle characteristic (viewing angle dependence of the gamma characteristic).

According to the multi-dot driving, in a case where a target luminance is intended to be displayed in a display dot, a display control is carried out so that an average of the different luminances of the plurality of subdots is equal to the target luminance. For example, according to a conventional multi-dot driving, a target luminance in halftone, in which a difference becomes greater between a luminance obtained when viewed from a front direction and a luminance obtained when viewed from an oblique direction, is achieved as follows. That is, some of the plurality of subdots have a luminance in the vicinity of a bright luminance and the others of the plurality of subdots have a luminance in the vicinity of a dark luminance. Note that, in the vicinities of the bright and dark luminances, a difference is small between a luminance obtained when viewed from a front direction and a luminance obtained when viewed from an oblique direction. This allows the entire display dot to have such a target luminance in halftone, as a result of spatial averaging of the luminances of the plurality of subdots.

This reduces a difference between a luminance obtained when viewed from a front direction and a luminance obtained when viewed from an oblique direction, thereby suppressing excess brightness that occurs when a halftone display is viewed from an oblique direction. As described above, with the employment of a multi-dot driving such as that disclosed in Patent Literature 1, it is possible to reduce a difference between a gamma characteristic obtained when a liquid crystal display panel is viewed from a front direction and a gamma characteristic obtained when the liquid crystal display panel is viewed from an oblique direction.

### CITATION LIST

### Patent Literatures

Patent Literature 1
Japanese Patent Application Publication, Tokukai, No. 2004-62146 A (Publication Date: Feb. 26, 2004)
Patent Literature 2
Japanese Patent Application Publication, Tokukaihei, No. 7-121144 A (Publication Date: May 12, 1995)

### SUMMARY OF INVENTION

### Technical Problem

The foregoing multi-dot driving is suitably used in a large liquid crystal display panel in which each dot is relatively large, because the each dot is divided into two or more subdots. However, a small liquid crystal display panel with higher definition, such as that for use in a mobile device, has dots each of which is small in size. Therefore, if such a small dot is subdivided into a plurality of subdots, then a dot structure becomes complicated and an aperture ratio is dramatically reduced. As a result, a sufficient luminance cannot be achieved.

The present invention has been made in view of the problems, and an object of the present invention is to further improve display quality by reducing, without making a dot structure complicated, a difference between a gamma characteristic obtained when a liquid crystal display panel is viewed from a front direction and a gamma characteristic obtained when the liquid crystal display panel is viewed from an oblique direction.

### Solution to Problem

In order to attain the above object, a method for driving a liquid crystal display device in accordance with the present invention is a method for driving a liquid crystal display device, the liquid crystal display device including a liquid crystal display panel that includes: a plurality of data signal lines; a plurality of scanning signal lines intersecting the plurality of data signal lines; and dots which are provided, in a matrix manner, for intersections of the plurality of data signal lines and the plurality of scanning signal lines, said method, including the steps of: (a) dividing the dots into a plurality of units each of which includes a predetermined number of dots; and (b) supplying pieces of gray scale data, into which a piece of input gray scale data is converted and which differ from location to location, to the respective dots in each of the plurality of units so that a target gray scale display is carried out in said each of the plurality of units.

A conventional method in which a dot is divided into a plurality of subdots causes problems that a configuration becomes complicated and an aperture ratio of the dot is reduced. Therefore, the conventional method is difficult to be put into practical use particularly in a portable liquid crystal display device including a relatively small liquid crystal display panel.

In this regard, according to the above configuration, each dot is not divided. Instead, each of the plurality of units includes the plurality of dots, and an area-division display can be carried out for the each of the plurality of units. This makes it possible to prevent complexity of a dot structure and a reduction in the aperture ratio of the plurality of dots. Further, according to the above method, a piece of the input gray scale data is converted into one of a plurality of different pieces of gray scale data. For example, a piece of halftone gray scale data is converted into one of two pieces of gray scale data (i.e., a piece of gray scale data having a gray scale level higher than the halftone gray scale level and a piece of gray scale data having a gray scale level lower than the halftone gray scale level). This reduces a difference between a gamma characteristic obtained when viewed from a front direction and a gamma characteristic obtained when viewed from an oblique direction. Accordingly, it is possible to reduce a difference between how each unit looks when viewed from a front direction and how it looks when viewed from an oblique direction, and thus makes it possible to ultimately improve display quality.

Note here that, as described above, in a case where the target gray scale display is carried out in the each of the plurality of units by supplying different pieces of the gray scale data to the respective dots in each of the plurality of units, the conversion is carried out so that a spatial average of the pieces of the gray scale data supplied to the respective dots in the each of the plurality of units causes a gray scale display based on the piece of the input gray scale data. This makes it possible to carry out a display based on the piece of the input gray scale data (i.e., the target gray scale display) in the entire each of the plurality of units, as a result of spatial averaging of the different pieces of the gray scale data of the respective dots in the each of the plurality of units.

The method in accordance with the present invention can be configured such that the step (b) includes the steps of: (c) detecting location information, indicating which dot receives the piece of input gray scale data, in accordance with the piece of input gray scale data and an input sync signal that corresponds to the piece of input gray scale data; and (d) causing the piece of input gray scale data to be converted into the pieces of gray scale data so as to (i) differ from location to location in accordance with the location information and then (ii) supply the pieces of gray scale data to the respective dots.

Note here that, the above method, in which the each of the plurality of units includes the two or more of the dots and the area-division driving is carried out for the each of the plurality of units, causes the following problem. That is, while the above method makes it possible to improve a gamma characteristic obtained when viewed from an oblique direction, the above method causes a deterioration in resolution.

In view of this, it is preferable that the method in accordance with the present invention further include the step of: (e) carrying out a time-division driving in which an average of pieces of gray scale data, which are displayed during entire frame periods of a unit cycle which corresponds to a plurality of successive frames, serves as display gray scale data of the unit cycle.

According to the above method, the time-division driving is employed in addition to the area-division driving. According to the time-division driving, one (1) unit cycle includes a plurality of successive frames; different pieces of gray scale data are written during the respective plurality of successive frames; and a time-average of the different pieces of the gray scale data serves as a piece of gray scale data to be displayed during the unit cycle.

According to the above method, it is possible to carry out the target gray scale display in the each of the plurality of units including the two or more of the dots. Not only that, it is possible to carry out, in each of the dots, displays based on the different pieces of the gray scale data during the respective plurality of successive frames. This makes it possible to prevent a deterioration in resolution, which deterioration occurs as a result of the area-division driving carried out for the each of the plurality of units.

Meanwhile, Patent Literature 2 discloses a technique in which the time-division driving is employed in a liquid crystal display device so as to achieve a wide viewing angle (i.e., a technique in which gamma characteristics of image signals are changed for every n frames [n≧2] to obtain liquid crystal drive voltages). However, since the technique employs only the time-division driving so as to change the gamma characteristics, the technique causes a problem that flicker is obvious.

In this regard, the above method employs both the area-division driving and the time-division driving so that the gamma characteristic obtained when viewed from the oblique direction is close to the gamma characteristic obtained when viewed from the front direction. This makes it possible to suppress flicker and achieve a uniform display in an entire panel.

The method in accordance with the present invention is preferably configured such that, in the step (d), the piece of input gray scale data is converted with reference to one of a plurality of lookup tables; and said one of the plurality of lookup tables is selected in accordance with the location information.

This method makes it possible to convert the piece of the gray scale data with reference to the plurality of lookup tables, thereby making the conversion easier. Accordingly, it is possible to simplify configurations such as those of circuits etc. that are necessary for the conversion of the gray scale data.

The method in accordance with the present invention is preferably configured such that, in the step (d), the piece of input gray scale data is converted with reference to one of a plurality of lookup tables; and said one of the plurality of lookup tables is selected in accordance with (i) the location information and (ii) frame information indicating which frame of the unit cycle corresponds to the piece of input gray scale data.

This method makes it possible to convert the piece of the gray scale data with reference to the plurality of lookup tables, thereby making the conversion easier. Accordingly, it is possible to simplify configurations such as those of circuits etc. that are necessary for the conversion of the gray scale data.

The present invention in accordance with the present invention can be configured such that the number of the plurality of lookup tables is 2, 3, or 4.

According to this method, since the number of the plurality of lookup tables is 2, 3, or 4, the piece of the input gray scale data can be converted, in the step (d), in two, three, or four different ways, respectively. Accordingly, the each of the plurality of units can cause a display based on an average of two, three, or four different pieces of the gray scale data.

The method in accordance with the present invention can be configured such that, in a case where (i) the liquid crystal display device includes a red color filter, a green color filter, and a blue color filter and (ii) each pixel includes a corresponding red dot, a corresponding green dot, and a corresponding blue dot of the dots, each of the plurality of units includes (a) four pixels of (two pixels×two pixels) or (b) sixteen pixels of (four pixels×four pixels).

The method in accordance with the present invention can be configured such that wherein the number of the plurality of successive frames in said each unit cycle is 2 or 4.

The method in accordance with the present invention is preferably configured such that, in a case where (i) a signal voltage applied to each of the plurality of data signal lines is dot-inversion driven, (ii) the liquid crystal display device includes a red color filter, a green color filter, and a blue color filter, and (iii) each pixel includes a corresponding red dot, a corresponding green dot, and a corresponding blue dot of the dots, in the step (d), pieces of gray scale data which are supplied to the respective dots of the each pixel during one of the plurality of successive frames of the unit cycle, to which dots the signal voltages having an identical polarity are applied, are subjected to an identical way of converting.

According to the dot reversal driving, polarities of voltages applied to the plurality of data signal lines are reversed every horizontal scanning period; and any adjacent ones of the plurality of data signal lines have respective different polarities.

With the employment of the dot reversal driving, it is possible to prevent shadowing (cross-talk) in a display.

Note here that, “in the step (d), . . . are subjected to an identical way of converting” means that, for example in a case where the gray scale data is converted with reference to lookup tables, an identical one of the lookup tables is referred to when pieces of the gray scale data are converted.

According to the above method, during each of the plurality of successive frames, corresponding ones of the dots having an identical polarity in each of the pixels are supplied with pieces of the gray scale data of the same kind, and corresponding ones of the dots having different polarities in the each of the pixels are supplied with pieces of the gray scale data of different kinds. This makes it possible to suppress image sticking and display unevenness, which may occur when the method in accordance with the present invention is applied to a liquid crystal display that employs the dot reversal driving.

In order to attain the above object, a liquid crystal display device in accordance with the present invention is a liquid crystal display device, including: a liquid crystal display panel that includes: a plurality of data signal lines; a plurality of scanning signal lines intersecting the plurality of data signal lines; and dots which are provided, in a matrix manner, for intersections of the plurality of data signal lines and the plurality of scanning signal lines, said liquid crystal display device, further including: a display drive section for (a) dividing the dots into a plurality of units each of which includes a predetermined number of dots and (b) supplying pieces of gray scale data, into which a piece of input gray scale data is converted and which differ from location to location, to the respective dots in each of the plurality of units so that a gray scale display obtained when the entire each of the plurality of units is viewed becomes a target gray scale display.

A conventional method in which a dot is divided into a plurality of subdots causes problems that a configuration becomes complicated and an aperture ratio of the dot is reduced. Therefore, the conventional method is difficult to be put into practical use particularly in a portable liquid crystal display device including a relatively small liquid crystal display panel.

In this regard, according to the above configuration, each dot is not divided. Instead, each of the plurality of units includes the plurality of dots, and an area-division display can be carried out for the each of the plurality of units. This makes it possible to prevent complexity of a dot structure and a reduction in the aperture ratio of the plurality of dots. Further, according to the above configuration, a piece of the input gray scale data is converted into one of a plurality of different pieces of gray scale data. For example, a piece of halftone gray scale data is converted into one of two pieces of gray scale data (i.e., a piece of gray scale data having a gray scale level higher than the halftone gray scale level and a piece of gray scale data having a gray scale level lower than the halftone gray scale level). This reduces a difference between a gamma characteristic obtained when viewed from a front direction and a gamma characteristic obtained when viewed from an oblique direction. Accordingly, it is possible to reduce a difference between how each unit looks when viewed from a front direction and how it looks when viewed from an oblique direction, and thus makes it possible to ultimately improve display quality.

Note here that, as described above, in a case where the target gray scale display is carried out in the each of the plurality of units by supplying different pieces of the gray scale data to the respective dots in each of the plurality of units, the conversion is carried out so that a spatial average of the pieces of the gray scale data supplied to the respective dots in the each of the plurality of units causes a gray scale display based on the piece of the input gray scale data. This makes it possible to carry out a display based on the piece of the input gray scale data (i.e., the target gray scale display) in the entire each of the plurality of units, as a result of spatial averaging of the different pieces of the gray scale data of the respective dots in the each of the plurality of units.

The liquid crystal display device in accordance with the present invention can be configured such that: the display drive section includes: (c) location information detection section which detects location information indicating which dot receives the piece of input gray scale data, in accordance with the piece of input gray scale data and an input sync signal that corresponds to the piece of input gray scale data; and (d) a gray scale data conversion section which causes the piece of input gray scale data to be converted into the pieces of gray scale data so as to (i) differ from location to location in accordance with the location information and then (ii) supply the pieces of gray scale data to the respective dots.

Note here that, the above configuration, in which the each of the plurality of units includes the two or more of the dots and the area-division driving is carried out for the each of the plurality of units, causes the following problem. That is, while the above configuration makes it possible to improve a gamma characteristic obtained when viewed from an oblique direction, the above configuration causes a deterioration in resolution.

In view of this, the liquid crystal display device in accordance with the present invention is preferably configured such that the display drive section further carries out a time-division driving in which an average of pieces of gray scale data, which are displayed during entire frame periods of a unit cycle which corresponds to a plurality of successive frames, serves as display gray scale data of the unit cycle.

According to the above configuration, the time-division driving is employed in addition to the area-division driving. According to the time-division driving, one (1) unit cycle includes a plurality of successive frames; different pieces of gray scale data are written during the respective plurality of successive frames; and a time-average of the different pieces of the gray scale data serves as a piece of gray scale data to be displayed during the unit cycle.

According to the above configuration, it is possible to carry out the target gray scale display in the each of the plurality of units including the two or more of the dots. Not only that, it is possible to carry out, in each of the dots, displays based on the different pieces of the gray scale data during the respective plurality of successive frames in the unit cycle. This makes it possible to prevent a deterioration in resolution, which deterioration occurs as a result of the area-division driving carried out for the each unit.

The liquid crystal display device in accordance with the present invention is preferably configured such that: the gray scale data conversion section selects one of a plurality of lookup tables in accordance with the location information, and converts the piece of input gray scale data with reference to said one of the plurality of lookup tables.

This configuration makes it possible to convert the piece of the gray scale data with reference to the plurality of lookup tables, thereby making the conversion easier. Accordingly, it is possible to simplify configurations such as those of circuits etc. that are necessary for the conversion of the gray scale data.

The liquid crystal display device in accordance with the present invention is preferably configured such that: the gray scale data conversion section (i) selects one of a plurality of lookup tables in accordance with (a) the location information and (b) frame information indicating which frame of the unit cycle corresponds to the piece of input gray scale data, and (ii) converts the piece of input gray scale data with reference to said one of the plurality of lookup tables.

This configuration makes it possible to convert the piece of the gray scale data with reference to the plurality of lookup tables, thereby making the conversion easier. Accordingly, it is possible to simplify configurations such as those of circuits etc. that are necessary for the conversion of the gray scale data.

The liquid crystal display device in accordance with the present invention can be configured such that the number of the plurality of lookup tables is 2, 3, or 4.

According to this configuration, since the number of the plurality of lookup tables is 2, 3, or 4, the piece of the input gray scale data can be converted, in the gray scale data conversion section, in two, three, or four different ways, respectively. Accordingly, the each of the plurality of units can cause a display based on an average of two, three, or four different pieces of the gray scale data.

The liquid crystal display device in accordance with the present invention can be configured such that, in a case where (i) the liquid crystal display device includes a red color filter, a green color filter, and a blue color filter and (ii) each pixel includes a corresponding red dot, a corresponding green dot, and a corresponding blue dot of the dots, each of the plurality of units includes (a) four pixels of (two pixels×two pixels) or (b) sixteen pixels of (four pixels×four pixels).

The liquid crystal display device in accordance with the present invention can be configured such that the number of the plurality of successive frames in said each unit cycle is 2 or 4.

The liquid crystal display device in accordance with the present invention is preferably configured such that, in a case where (i) a signal voltage applied to each of the plurality of data signal lines is dot-inversion driven, (ii) the liquid crystal display device includes a red color filter, a green color filter, and a blue color filter, and (iii) each pixel includes a corresponding red dot, a corresponding green dot, and a corresponding blue dot of the dots, in the gray scale data conversion section, pieces of gray scale data which are supplied to the respective dots of the each pixel during one of the plurality of successive frames of the unit cycle, to which dots the signal voltages having an identical polarity are applied, are subjected to an identical way of converting.

With the employment of the dot reversal driving, the configuration makes it possible to prevent shadowing (cross-talk) in a display.

Note here that, “in the gray scale data conversion section, . . . are subjected to an identical way of converting” means that, for example in a case where the gray scale data is converted with reference to lookup tables, an identical one of the lookup tables is referred to when pieces of the gray scale data are converted.

According to the above configuration, during each of the plurality of successive frames, corresponding ones of the dots having an identical polarity in each of the pixels are supplied with pieces of the gray scale data of the same kind, and corresponding ones of the dots having different polarities in the each of the pixels are supplied with pieces of the gray scale data of different kinds. This makes it possible to suppress image sticking and display unevenness, which may occur when the method of driving the liquid crystal display device in accordance with the present invention is applied to a liquid crystal display that employs the dot reversal driving.

The liquid crystal display device in accordance with the present invention can be configured such that the liquid crystal display panel is a normally black liquid crystal display panel. With application of the present invention to a normally black liquid crystal display device, it is possible to more suppress excess brightness of a display image and thus to improve a contrast. Accordingly, it is possible to achieve a liquid crystal display device with a further improved display quality.

### ADVANTAGEOUS EFFECTS OF INVENTION

A method for driving a liquid crystal display device in accordance with the present invention includes the steps of (a) dividing the dots into a plurality of units each of which includes a predetermined number of dots; and (b) supplying pieces of gray scale data, into which a piece of input gray scale data is converted and which differ from location to location, to the respective dots in each of the plurality of units so that a target gray scale display is carried out in said each of the plurality of units.

A liquid crystal display device in accordance with the present invention includes a display drive section for (a) dividing the dots into a plurality of units each of which includes a predetermined number of dots and (b) supplying pieces of gray scale data, into which a piece of input gray scale data is converted and which differ from location to location, to the respective dots in each of the plurality of units so that a gray scale display obtained when the entire each of the plurality of units is viewed becomes a target gray scale display.

According to the present invention, it is possible to further improve display quality by reducing, without making a dot structure complicated, a difference between a gamma characteristic obtained when a liquid crystal display panel is viewed from a front direction and a gamma characteristic obtained when the liquid crystal display panel is viewed from an oblique direction.

For a fuller understanding of other objects, the nature, and advantages of the invention, reference should be made to the ensuing detailed description taken in conjunction with the accompanying drawings.

### BRIEF DESCRIPTION OF DRAWINGS

FIG. 1 is a block diagram illustrating how a liquid crystal display device of a first, second, fifth, and sixth embodiments of the present invention is configured.

FIG. 2 is a plan view illustrating how a liquid crystal display panel included in a liquid crystal display device of one embodiment of the present invention is configured.

FIG. 3, showing the liquid crystal display device of the first embodiment of the present invention, is a view schematically illustrating how a unit including a plurality of dots is configured.

FIG. 4 is a graph illustrating measurement results of how gray scale levels are related to transmittance in the liquid crystal display device of the first embodiment of the present invention.

FIG. 5 is a schematic view illustrating how a dot reversal driving is carried out in a liquid crystal display device.

FIG. 6, showing the liquid crystal display device of the second embodiment of the present invention, is a view schematically illustrating how a unit including a plurality of dots is configured.

FIG. 7 is a graph illustrating measurement results of how gray scale levels are related to transmittance in the liquid crystal display device of the second embodiment of the present invention.

FIG. 8 is a block diagram illustrating how a liquid crystal display device of a third, fourth, seventh, and eighth embodiments of the present invention is configured.

FIG. 9, showing the liquid crystal display device of the third embodiment of the present invention, is a view schematically illustrating how a unit including a plurality of dots is configured.

FIG. 10 is a graph illustrating measurement results of how gray scale levels are related to transmittance in the liquid crystal display device of the third embodiment of the present invention.

FIG. 11, showing the liquid crystal display device of the fourth embodiment of the present invention, is a view schematically illustrating how a unit including a plurality of dots is configured.

FIG. 12 is a graph illustrating measurement results of how gray scale levels are related to transmittance in the liquid crystal display device of the fourth embodiment of the present invention.

FIG. 13, showing the liquid crystal display device of the fifth embodiment of the present invention, is a view schematically illustrating how a unit including a plurality of dots is configured.

FIG. 14 is a graph illustrating measurement results of how gray scale levels are related to transmittance in the liquid crystal display device of the fifth embodiment of the present invention.

FIG. 15, showing the liquid crystal display device of the sixth embodiment of the present invention, is a view schematically illustrating how a unit including a plurality of dots is configured.

FIG. 16 is a graph illustrating measurement results of how gray scale levels are related to transmittance in the liquid crystal display device of the sixth embodiment of the present invention.

FIG. 17, showing the liquid crystal display device of the seventh embodiment of the present invention, is a view schematically illustrating how a unit including a plurality of dots is configured.

FIG. 18 is a graph illustrating measurement results of how gray scale levels are related to transmittance in the liquid crystal display device of the seventh embodiment of the present invention.

FIG. 19, showing the liquid crystal display device of the eighth embodiment of the present invention, is a view schematically illustrating how a unit including a plurality of dots is configured.

FIG. 20 is a graph illustrating measurement results of how gray scale levels are related to transmittance in the liquid crystal display device of the eighth embodiment of the present invention.

### DESCRIPTION OF EMBODIMENTS

### Embodiment 1

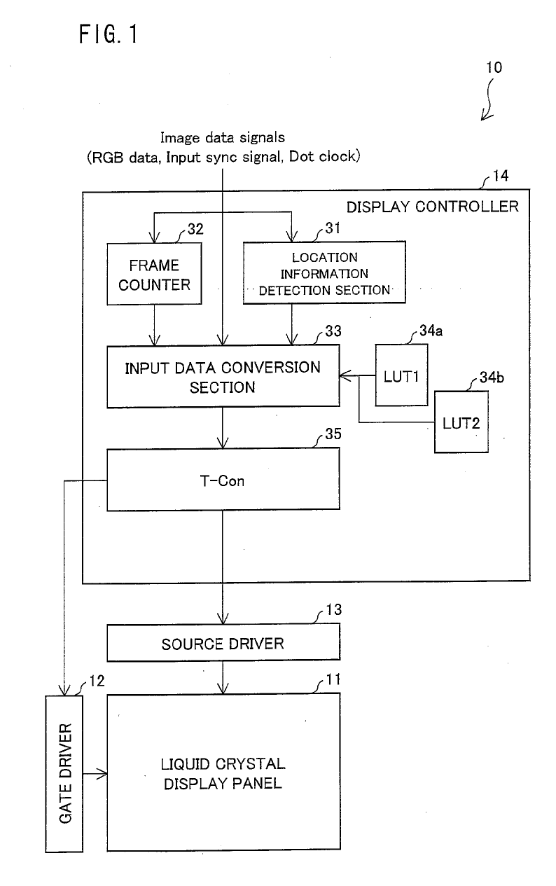

A first embodiment in accordance with the present invention is described below with reference to FIGS. 1 through 5.

In the present embodiment, a portable liquid crystal display device such as a mobile phone is described as one example of a liquid crystal display device in accordance with the present invention. Note, however, that the present invention is not limited to such a portable liquid crystal display device.

A liquid crystal display device of the present embodiment employs a so-called area-division driving so as to carry out a display. According to the display employing the area-division driving, (i) the dots are divided into a plurality of units each of which includes a predetermined number of dots, (ii) different pieces of gray scale data are supplied to dots in each of the plurality of units, and (iii) an average of the pieces of gray scale data causes a target gray scale display in each of the plurality of units. Further, the liquid crystal display device of the present embodiment employs a time-division driving in addition to the area-division driving. According to the time-division driving, one (1) unit cycle includes a plurality of successive frames; and an average of pieces of gray scale data to be displayed during the respective plurality of successive frames of the unit cycle serves as a piece of gray scale data to be displayed during the unit cycle.

FIG. 1 illustrates how a liquid crystal display device 10 of the present embodiment is configured.

As illustrated in FIG. 1, the liquid crystal display device 10 includes, as main constituents, a liquid crystal display panel 11, a backlight (not illustrated), a gate driver 12, a source driver 13, a display controller 14 (display drive section), and the like.

The liquid crystal display panel 11 is constituted by: an active matrix substrate; a counter substrate; and a liquid crystal layer sandwiched between the active matrix substrate and the counter substrate. A mode such as an MVA mode, a TN mode, or an IPS mode can be used as a display mode of the liquid crystal display panel 11 of the present embodiment. Note, however, that the present invention is more preferably applied to a normally black liquid crystal display panel, in which a black display is carried out while no voltage is being applied. Examples of such a normally black liquid crystal display panel encompass: an IPS liquid crystal display panel, the MVA liquid crystal display panel, and a CPA liquid crystal display panel. With the employment of such a normally black liquid crystal display panel, it is possible to increase a contrast and to ultimately improve display quality.

The present invention is further preferably applied to, among other display modes, a liquid crystal display panel such as the MVA liquid crystal display panel or the CPA liquid crystal display panel, which employs a vertical alignment. With the application of the present invention to such a liquid crystal display panel, it is possible to more effectively reduce a difference between a gamma characteristic obtained when viewed from a front direction and a gamma characteristic obtained when viewed from an oblique direction. This makes it possible to further improve display quality.

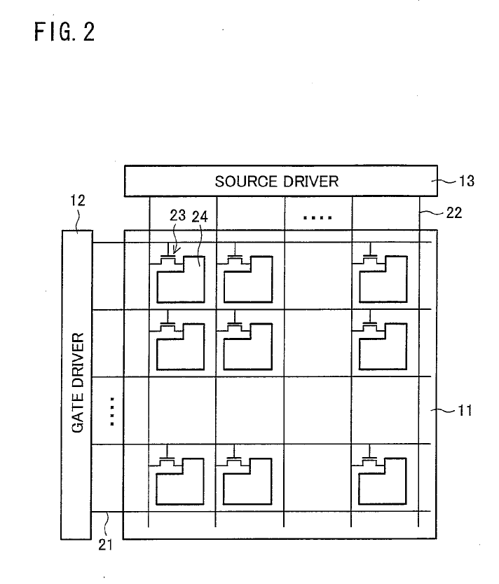

FIG. 2 illustrates how the liquid crystal display panel 11 of the liquid crystal display device 10 is configured. The active matrix substrate constituting the liquid crystal display panel 11 is provided with: a plurality of scanning signal lines 21 which are connected with the gate driver 12; a plurality of data signal lines 22, provided so as to intersect the plurality of scanning signal lines 21, which are connected with the source driver 13; and TFTs 23, serving as switching elements, which are provided in the vicinities of intersections of the plurality of scanning signal lines 21 and the plurality of data signal lines 22.

Dot electrodes 24 are provided in lattices defined by the plurality of scanning signal lines 21 and the plurality of data signal lines 22 which intersect each other. Each of the dot electrodes 24 constitutes a corresponding one of the dots.

As illustrated in FIG. 2, the dot electrodes 24 are electrically connected with the respective TFTs 23. Upon receiving a scanning signal, from a corresponding one of the plurality of scanning signal lines 21, which causes a corresponding one of the TFTs 23 to turn on, the corresponding one of the TFTs 23 connects a corresponding one of the dot electrodes 24 and a corresponding one of the plurality of data signal lines 22. This causes a corresponding data signal to be supplied to the corresponding one of the dot electrodes 24 via the corresponding one of the plurality of data signal lines 22. Accordingly, the corresponding one of the dot electrodes 24 causes a display based on the data signal thus supplied.

The backlight (not illustrated) is provided behind the liquid crystal display panel 11, and emits light toward the liquid crystal display panel 11.

The display controller 14 generates, in response to image data signals (input gray scale data [R, G, and B data], input sync signals [vertical sync signals and horizontal sync signals], and dot clocks) which are supplied from a signal source (not illustrated), signals causing an image to be displayed on the liquid crystal display panel 11. Note here that, in a case where the liquid crystal display device 10 is a mobile phone, the signal source is for example an image control system of the mobile phone. Instead, in a case where the liquid crystal display device 10 has a function of displaying television broadcasting, the signal source can be a receiving system which receives television broadcasting.

The display controller 14 includes: a location information detection section 31; a frame counter 32; an input data conversion section 33 (gray scale data conversion section); two different lookup tables 34a and 34b (LUT1 and LUT 2); a timing controller 35; and the like.

The location information detection section 31 detects location information that indicates which dot in the unit receives a piece of the input gray scale data, in accordance with the piece of the input gray scale data, a corresponding one of the input sync signals (i.e., a horizontal sync signal), and a corresponding one of the dot clocks.

The frame counter 32 calculates frame information, indicating which frame of the unit cycle corresponds to the piece of the input gray scale data, based on the piece of the input gray scale data and a corresponding one of the vertical sync signals.

The input data conversion section 33 converts the piece of the input gray scale data into pieces of gray scale data so that the pieces of the gray scale data differ from location to location in accordance with the location information detected by the location information detection section 31. Further, the input data conversion section 33 converts, in accordance with the frame information calculated by the frame counter 32, the piece of the input gray scale data into pieces of gray scale data so that the pieces of the gray scale data differ from frame to frame. This will be described later in detail.

Each of the lookup tables 34a and 34b (LUT1 and LUT2) is a table in which (i) pieces of the input gray scale data supplied to the input data conversion section 33 and (ii) pieces of gray scale data outputted from the input data conversion section 33 are stored so as to have one to one correspondence. The LUT1 and the LUT2 are referred to when the input data conversion section 33 converts the input gray scale data.

According to the display controller 14 configured like above, the plurality of dots are treated as the unit. The display controller 14 causes the piece of the gray scale data to be converted so that each of the plurality of dots in the unit receives one of pieces of the gray scale data of two different kinds. Gray scale displays are carried out in each of the plurality of units in accordance with the different pieces of the gray scale data, and an average of the pieces of the gray scale data causes each target gray scale display in each of the plurality of units.

The following description discusses a method of how the liquid crystal display device 10 specifically displays. Note here that the following description exemplifies a liquid crystal display device 10 that includes red (R), green (G), and blue (B) color filters.

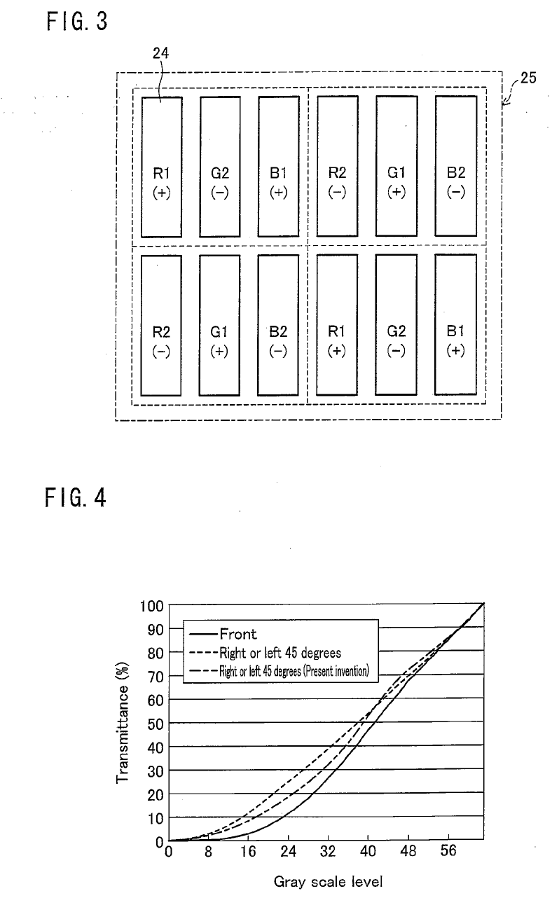

FIG. 3 illustrates how a unit 25 is configured in a case where the display is carried out in the present embodiment. Note here that, each of pixels (i.e., regions surrounded by dotted lines in FIG. 3) is defined as including a red (R) dot 24, a green (G) dot 24, and a blue (B) dot 24. According to the present embodiment, the unit 25 includes four pixels of (two pixels×two pixels) (see FIG. 3).

According to the present embodiment, the area-division driving is carried out with respect to each unit. That is, the display controller 14 (display drive section) carries out a data conversion process so that a piece of input gray scale data (a piece of R data, a piece of G data, a piece of B data) is converted into pieces of gray scale data which differ from location to location and are then supplied to the respective dots 24 in the unit 25 which is defined as including four the pixels (two pixels×two pixels). When the pieces of gray scale data are displayed in the dots 24 in the unit 25, an average of the pieces of gray scale data allows a gray scale display (i.e., a target gray scale display) to be achieved in the entire unit 25 in accordance with the piece of input gray scale data.

In addition to the area-division driving, the present embodiment further employs the time-division driving so as to suppress a deterioration in resolution which reduction may occur as a result of the area-division driving. According to the time-division driving, a unit cycle is defined as including a plurality of successive vertical periods (a plurality of successive frames); and a time-average of pieces of gray scale data to be displayed during the respective plurality of frames serves as a piece of gray scale data to be displayed during the unit cycle.

The following description discusses how the data conversion is carried out by the display controller 14.

As illustrated in FIG. 1, the display controller 14 receives, from the signal source (not illustrated), the piece of the input gray scale data (pieces of input gray scale data [R, G, and B data], the input sync signals [vertical sync signals and horizontal sync signals], and the dot clocks).

The location information detection section 31 of the display controller 14 detects location information that indicates which dot 24 in the unit 25 as shown in FIG. 3 receives a piece of the input gray scale data, in accordance with the piece of the input gray scale data, a corresponding one of the input sync signals (i.e., a horizontal sync signal), and a corresponding one of the dot clocks. Then, the location information detection section 31 outputs the location information thus detected.

The frame counter 32 counts the number of the input vertical sync signals (i.e., counts the number of frames), so as to find frame information indicating which frame corresponds to a piece of gray scale data corresponding to the vertical sync signal. Then, the frame counter 32 outputs the frame information thus found.

The location information and the frame information are supplied to the input data conversion section 33. The input data conversion section 33 converts the piece of the input gray scale data on the basis of the piece of the input gray scale data, the location information corresponding to the piece of the input gray scale data, and the frame information corresponding to the piece of the input gray scale data. Specifically, the input data conversion section 33 converts the piece of the input gray scale data, on the basis of the location information and the frame information, into pieces of gray scale data which are supplied to the respective dots 24 in the unit 25 and which differ (i) from location to location in the unit 25 and (ii) from frame to frame in the unit cycle.

According to the present embodiment, the conversion of the input gray scale data is carried out with reference to the two different lookup tables 34a and 34b. This makes it possible to carry out the conversion of the input gray scale data in two different ways.

That is, the input data conversion section 33 carries out the conversion of the input gray scale data in a way that differs (i) from location to location in the unit 25 and (ii) from frame to frame in the unit cycle by selecting, on the basis of the input location information and the input frame information, one of the two different lookup tables 34a and 34b.

The piece of the gray scale data thus converted is then supplied to the timing controller 35.

The timing controller 35 determines timings at which a scanning signal and a data signal are supplied to a corresponding one of the plurality of scanning signal lines 21 and a corresponding one of the plurality of data signal lines 22, respectively. Specifically, the timing controller 35 outputs, at predetermined timings, (i) clock signals generated in response to the input sync signals, (ii) various signals such as start pulse signals, and (iii) the pieces of the gray scale data converted by the input data conversion section 33.

The various signals outputted from the timing controller 35 are supplied to the plurality of scanning signal lines 21 and the plurality of data signal lines 22 of the liquid crystal display panel 11, via respective of the gate driver 12 and the source driver 13. Accordingly, in the liquid crystal display panel 11, (i) the current pieces of gray scale data that have been subjected to data conversion processes which differ from location to location are displayed, during a current frame, in the dots 24 of the unit 25 and (ii) in response to switching of the current frame to a next frame, next pieces of gray scale data which have been subjected to data conversion processes different from the current ones are displayed, during the next frame, in the dots 24 of the unit 25.

The following description discusses a more specific example of the data conversion process, which is employed in a case where (i) the unit 25 is configured as illustrated in FIG. 3 and (ii) it is intended to display, in the entire unit 25, a piece of gray scale data D (R, G, B).

In this case, the piece of the gray scale data D is converted into pieces of gray scale data of two different kinds, i.e., D1 (R1, G1, B1) and D2 (R2, G2, B2). Note here that the combination of the pieces of the gray scale data D1 and D2 is selected so that an average of them is equal to the piece of the gray scale data D in a case where the pieces of the gray scale data D1 and D2 are displayed in respective areas having an identical size for an identical period of time. For example, in a case of 6-bit gray scale data, a first lookup table 34a (LUT1) stores pieces of output gray scale data D1 for respective pieces of input gray scale data D (0 through 63), and a second lookup table 34b (LUT2) stores pieces of output gray scale data D2 for the respective pieces of the input gray scale data D (0 through 63).

The input data conversion section 33 (i) selects, on the basis of the location information detected by the location information detection section 31 and the frame information counted by the frame counter 32, one of the D1 and D2 to be displayed, during a specific frame period, in each of the dots 24 of the unit 25 and then (ii) determines pieces of gray scale data, as respective converted ones, received from a selected one of the LUTs 34a and 34b.

FIG. 3 illustrates one example of pieces of gray scale data, which have been subjected to the data conversion process, obtained during a certain frame period. As is clear from FIG. 3, a display ratio (area ratio) of the D1 (R1, G1, B1) to the D2 (R2, G2, B2), i.e., (D1:D2) is equal to (1:1).

This causes mix of the D1 and D2 to be displayed during a certain frame period. Note, however, that the entire unit is perceived as having the piece of the gray scale data D, as a result of spatial averaging.

The present embodiment employs the time-division driving in which: one (1) unit cycle includes two frame periods, i.e., (i) a first half (a first frame period) during which a piece of gray scale data D1 is displayed and (ii) a second half (a second frame period) during which a piece of gray scale data D2 is displayed; and a piece of gray scale data D, obtained by averaging the piece of the gray scale data D1 and the piece of the gray scale data D2, serves as a piece of gray scale data to be displayed during the unit cycle.

The piece of the gray scale data D1 and the piece of the gray scale data D2 are displayed alternately every other frame. That is, the piece of identical data is displayed every two frames. Therefore, each of the dots is perceived as having the piece of the gray scale data D, as a result of time-average.

This allows the entire unit to achieve a display that is uniform in terms of time and space, and therefore can prevent display unevenness and a deterioration in resolution.

Note here that, which gray scale data D1 and D2 to obtain from the piece of the gray scale data D can be determined in accordance with a conventional method for converting pieces of gray scale data. The conventional method is employed in a display drive of a multi-dot driving type (see, for example, Patent Literature 1).

For example, a target luminance in a halftone, in which a difference becomes greater between a luminance obtained when viewed from a front direction and a luminance obtained when viewed from an oblique direction, is achieved as follows. That is, gray scale displays are carried out in the dots 24 of the unit 25 so that some of the dots 24 have a luminance in the vicinity of a bright luminance and the others of the dots 24 have a luminance in the vicinity of a dark luminance. Note that, in the vicinities of the bright and dark luminances, a difference is small between a luminance obtained when viewed from a front direction and a luminance obtained when viewed from an oblique direction. This allows the entire unit 25 to have such a target luminance in halftone, as a result of spatial averaging of the luminances of the dots 24 in the unit 25.

As a result, it is possible to reduce a difference between a gamma characteristic obtained when the liquid crystal display panel is viewed from a front direction and a gamma characteristic obtained when the liquid crystal display panel is viewed from an oblique direction.

According to a conventional multi-dot driving, a dot is divided into a plurality of subdots. Therefore, the conventional multi-dot driving causes problems that a configuration becomes complicated and an aperture ratio of the dot is reduced. In this regard, according to the configuration of the present embodiment, each dot is not divided. Instead, each unit includes a plurality of dots, and an area-division display can be carried out for each unit. This makes it possible to reduce a difference between how each unit looks when viewed from a front direction and how it looks when viewed from an oblique direction, without making a dot structure complicated, and thus makes it possible to ultimately improve display quality.

FIG. 4 is a graph illustrating measurement results of a gray scale-luminance characteristic (how a gray scale level and transmittance are related) obtained when a drive method of the present embodiment is employed in an MVA liquid crystal display device. The graph of FIG. 4 illustrates, for comparison, also a result obtained when a conventional drive method is employed. In FIG. 4, (i) a solid line indicates a gray scale-luminance characteristic obtained when a liquid crystal display panel is viewed from a front direction (this characteristic is common to the method of the present embodiment and the conventional method), (ii) a dashed line indicates a gray scale-luminance characteristic obtained when the liquid crystal display device employs the drive method of the present embodiment and the liquid crystal display panel is viewed from a right or left oblique direction at an angle of 45 degrees to the liquid crystal display panel, and (iii) a dotted line indicates a gray scale-luminance characteristic obtained when the liquid crystal display device employs the conventional drive method and the liquid crystal display panel is viewed from the right or left oblique direction at the angle of 45 degrees to the liquid crystal display panel.

As is clear from the graph of FIG. 4, in a case where the drive method of the present embodiment is employed, it is possible to suppress a phenomenon of the luminance becoming high when viewed from an oblique direction (such a phenomenon is called excess brightness), as compared with the case where the conventional drive method is employed.

In a case of 6-bit data (the total number of gray scale levels is 64), an “excess brightness rate”, based on which a degree of the excess brightness is evaluated, is determined as follows:

Excess brightness rate=(Luminance of gray scale level 31 obtained when viewed from oblique direction−Luminance of gray scale level 31 obtained when viewed from front direction)/(Luminance of gray scale level 31 obtained when viewed from front direction)

The excess brightness rates illustrated in FIG. 4 were as follows:

Drive method of present embodiment: Excess brightness rate=25.6%

Conventional drive method: Excess brightness rate:=53.6%

Meanwhile, according to the present embodiment, (i) a G dot and (ii) R and B dots in each of the pixels are supplied with pieces of the gray scale data of different kinds (D1 and D2) in each frame period (see FIG. 3).

This is because the liquid crystal display device 10 of the present embodiment employs a dot reversal driving in which polarities of signal voltages applied to the respective plurality of data signal lines are reversed. Since each of the R and B dots has a polarity reverse to a polarity of the G dot during the dot reversal driving, the each of the R and B dots has a pull-in voltage characteristic different from that of the G dot. Under such circumstances, if pieces of identical gray scale data are supplied to the R, G, and B dots, then (i) the G dot and (ii) the R and B dots are caused to have slightly different displays. This is due to the difference in the pull-in voltages, which difference results from the difference between the polarities of (i) the G dot and (ii) the R and B dots. This may cause display unevenness.

In view of the difference in the polarities, (i) a piece of gray scale data to be written into the G dot and (ii) pieces of gray scale data to be written into the R and B dots are different from each other. This makes it possible to cause each of all the G, R, and B dots to display with their positive polarities only, or to display with their negative polarities only. Accordingly, it is possible to suppress display unevenness that is caused by the difference in the polarities.

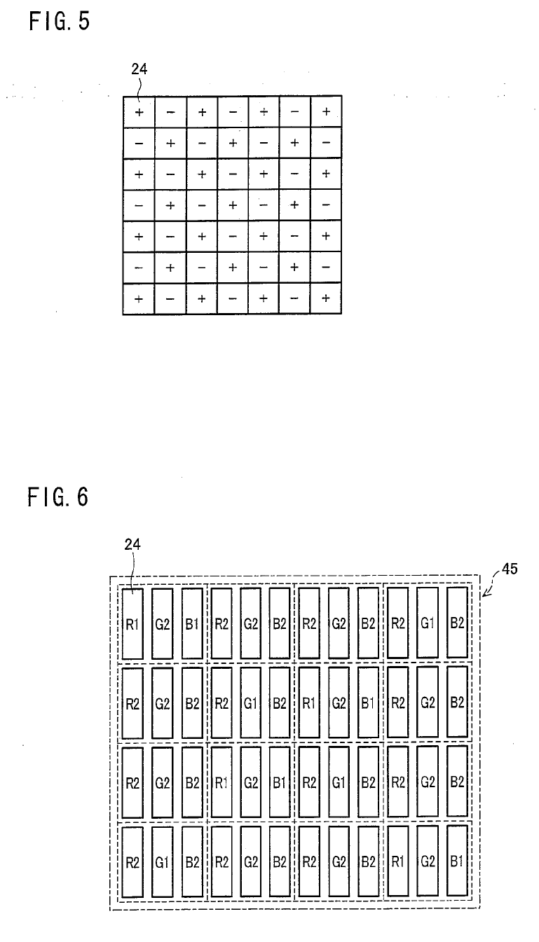

FIG. 5 schematically illustrates polarities of signal voltages supplied to the respective dots 24, obtained when the dot reversal driving is employed. Refer also to FIG. 3, in which polarities of the respective dots during a certain frame period are shown in parenthesis. As is clear from FIGS. 3 and 5, any adjacent ones of the dots have respective different polarities in the case where the dot reversal driving is employed.

Under such circumstances, the present embodiment is configured such that, during each frame period, pieces of the gray scale data of the same kind are selected as the pieces of the gray scale data to be supplied to dots, whose polarities are identical, in each of the pixels. For example, in FIG. 3, pieces of the gray scale data D1 are selected as the respective pieces of the gray scale data to be supplied to dots each having a positive polarity (e.g., the R and B dots in an upper-left pixel of the unit 25), whereas pieces of the gray scale data D2 are selected as the respective pieces of the gray scale data to be supplied to dots each having a negative polarity (e.g., the G dot in the upper-left pixel in the unit 25). This makes it possible to suppress image sticking and unevenness of pattern during the time-division driving.

### Embodiment 2

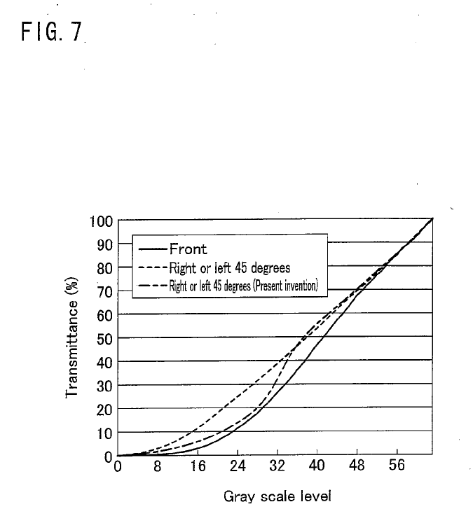

A second embodiment in accordance with the present invention is described below with reference to FIGS. 6 and 7.

As is the case with Embodiment 1, a liquid crystal display device of the present embodiment also employs both the area-division driving and the time-division driving so as to carry out a display. Therefore, a liquid crystal display device 10 of the present embodiment has a configuration identical to that of the liquid crystal display device of Embodiment 1 (see FIG. 1). The following description discusses only how a drive method of the present embodiment is different from the drive method of Embodiment 1.

FIG. 6 illustrates how a unit 45 is configured in a case where the display is carried out in the present embodiment. Note here that each of pixels (i.e., regions surrounded by dotted lines in FIG. 6) is defined as including a red (R) dot 24, a green (G) dot 24, and a blue (B) dot 24. According to the present embodiment, one (1) unit 45 includes sixteen pixels of (four pixels×four pixels) (see FIG. 6).

The following description discusses data conversion that is carried out in a case where (i) the unit 45 is configured as illustrated in FIG. 6 and (ii) it is intended to display, in the entire unit 45, a piece of gray scale data D (R, G, B).

In this case, the piece of the gray scale data D is converted into pieces of gray scale data of two different kinds, i.e., D1 (R1, G1, B1) and D2 (R2, G2, B2). Note here that the combination of the pieces of the gray scale data D1 and D2 is selected so that an average of them is equal to the piece of the gray scale data D in a case where the pieces of the gray scale data D1 and D2 are displayed such that (i) a display ratio (area ratio) of the D1 to D2, i.e., (D1:D2) is equal to 1:3 and (ii) a display ratio (time ratio) of the D1 to D2, i.e., (D1:D2) is equal to 1:3. For example, in a case of 6-bit gray scale data, a first lookup table 34a (LUT1) stores pieces of output gray scale data D1 for respective pieces of input gray scale data D (0 through 63), and a second lookup table 34b (LUT2) stores pieces of output gray scale data D2 for the respective pieces of the input gray scale data D (0 through 63).

The input data conversion section 33 (i) selects, on the basis of the location information detected by the location information detection section 31 and the frame information counted by the frame counter 32, one of the D1 and D2 to be displayed, during a specific frame period, in each of the dots 24 of the unit 45 and then (ii) determines pieces of gray scale data, as respective converted ones, received from a selected one of the LUT1 and LUT2.

FIG. 6 illustrates one example of pieces of gray scale data, which have been subjected to the data conversion process, obtained during a certain frame period. As is clear from FIG. 6, a display ratio (area ratio) of the D1 (R1, G1, B1) to the D2 (R2, G2, B2), i.e., (D1:D2) is equal to 1:3.

This causes mix of the D1 and D2 to be displayed during a certain frame period. Note, however, that the entire unit is perceived as having the piece of the gray scale data D, as a result of spatial averaging.

Further, the present embodiment employs the time-division driving in which: one (1) unit cycle includes four frame periods; and a piece of gray scale data D, obtained by averaging pieces of gray scale data to be displayed during the four frame periods, serves as a piece of gray scale data to be displayed during the unit cycle. That is, one (1) unit cycle includes successive four frame periods.

The piece of the gray scale data D1 and the piece of the gray scale data D2 are displayed alternately every other subframe. That is, the piece of identical data is displayed every four frames. Therefore, each of the dots is perceived as having the piece of the gray scale data D, as a result of time-average.

This allows the entire unit to achieve a display that is uniform in terms of time and space, and therefore can prevent display unevenness and a deterioration in resolution.

FIG. 7 is a graph illustrating measurement results of a gray scale-luminance characteristic (how a gray scale level and transmittance are related) obtained when a drive method of the present embodiment is employed in an MVA liquid crystal display device. The graph of FIG. 7 illustrates, for comparison, also a result obtained when a conventional drive method is employed. In FIG. 7, (i) a solid line indicates a gray scale-luminance characteristic obtained when a liquid crystal display panel is viewed from a front direction (this characteristic is common to the method of the present embodiment and the conventional method), (ii) a dashed line indicates a gray scale-luminance characteristic obtained when the liquid crystal display device employs the drive method of the present embodiment and the liquid crystal display panel is viewed from a right or left oblique direction at an angle of 45 degrees to the liquid crystal display panel, and (iii) a dotted line indicates a gray scale-luminance characteristic obtained when the liquid crystal display device employs the conventional drive method and the liquid crystal panel is viewed from a right or left oblique direction at an angle of 45 degrees to the liquid crystal display panel.

As is clear from the graph of FIG. 7, in a case where the drive method of the present embodiment is employed, it is possible to suppress a phenomenon of the luminance becoming high when viewed from an oblique direction (such a phenomenon is called excess brightness), as compared with the case where the conventional drive method is employed.

The “excess brightness rates” for the results illustrated in FIG. 7 are found in the same way as in Embodiment 1. The following “excess brightness rates” were obtained:

Drive method of present embodiment: Excess brightness rate=14.7%

Conventional drive method: Excess brightness rate=53.6%

These results show that the excess brightness rate was more suppressed in Embodiment 2 than in Embodiment 1, and the excess brightness particularly for low gray scale levels is suppressed. This is particularly advantageous when displaying a skin color etc. which has especially a lot of low gray scale levels and is therefore sensitive to excess brightness.

As is the case with Embodiment 1, according to the present embodiment, (i) a G dot and (ii) R and B dots in each of the pixels are supplied with pieces of the gray scale data of different kinds (D1 or D2) during a certain frame period (see FIG. 6), for the purpose of suppressing image sticking and flicker during the dot reversal driving. Note however that, since the display ratio (area ratio) of the D1 (R1, G1, B1) to the D2 (R2, G2, B2), i.e., (D1:D2) in the unit 45 is equal to 1:3 according to the present embodiment, the R, G, and B dots in each of some of the pixels in the unit 45 are supplied with pieces of the gray scale data of the same kind (see FIG. 6). In this regard, since selections of the LUTs are carried out such that each of the pixels is supplied with a combination of (R1, G2, B1) or of (R2, G1, B2) during a certain frame(s) in each unit cycle, it is possible to suppress image sticking and flicker.

### Embodiment 3

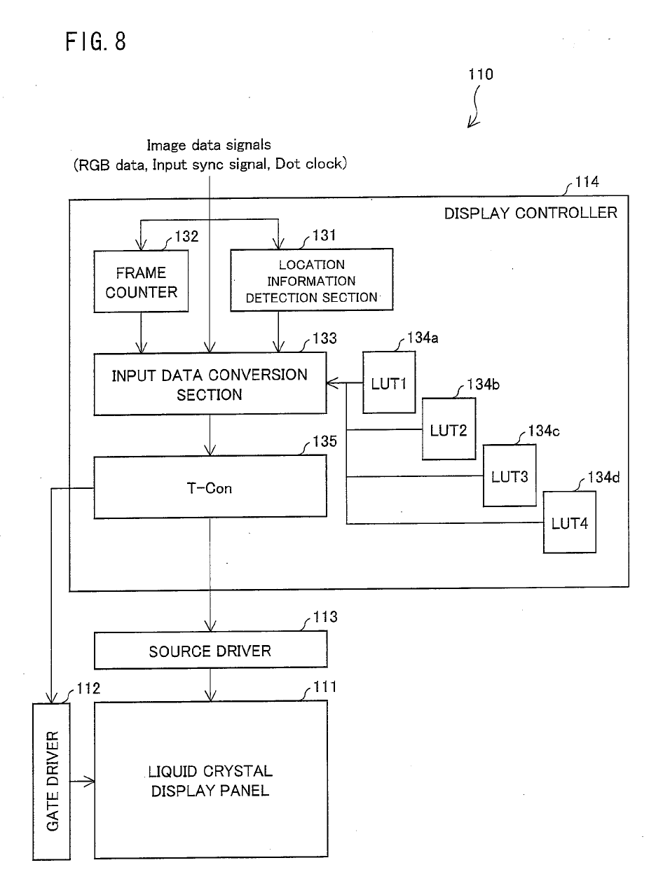

A third embodiment in accordance with the present invention is described below with reference to FIGS. 8 through 10.

As is the case with the foregoing embodiments, a liquid crystal display device of the present embodiment also employs both the area-division driving and the time-division driving so as to carry out a display.

FIG. 8 illustrates how a liquid crystal display device 110 of the present embodiment is configured.

As illustrated in FIG. 8, the liquid crystal display device 110 includes, as main constituents, a liquid crystal display panel 111, a backlight (not illustrated), a gate driver 112, a source driver 113, a display controller 114 (display drive section), and the like.

Since the liquid crystal display panel 111, the backlight, the gate driver 112, and the source driver 113 have configurations identical to those of the liquid crystal display panel 11, the backlight (not illustrated), the gate driver 12, and the source driver 13, respectively, of the liquid crystal display device 10 of FIG. 1, descriptions for the liquid crystal display panel 111, the backlight, the gate driver 112, and the source driver 113 are omitted here.

The display controller 114 also has a configuration substantially identical to that of the display controller 14 of FIG. 1, and includes: a location information detection section 131; a frame counter 132; an input data conversion section 133 (gray scale data conversion section); lookup tables 134a through 134d (LUT1 through LUT4); a timing controller 135; and the like. While the liquid crystal display device 10 of FIG. 1 includes two different lookup tables, the liquid crystal display device 110 includes four different lookup tables. This is a difference between the present embodiment and Embodiment 1.

According to the display controller 114 configured like above, a plurality of dots are treated as a unit. The display controller 114 causes a piece of gray scale data to be converted so that each of the plurality of dots in the unit receives one of pieces of gray scale data of four different kinds. Gray scale displays are carried out in each of the plurality of units in accordance with the different pieces of the gray scale data, and an average of the pieces of the gray scale data causes each target gray scale display in each of the plurality of units.

The following description discusses a method of how the liquid crystal display device 110 specifically displays. Note here that the following description exemplifies a liquid crystal display device 110 that includes red (R), green (G), and blue (B) color filters.

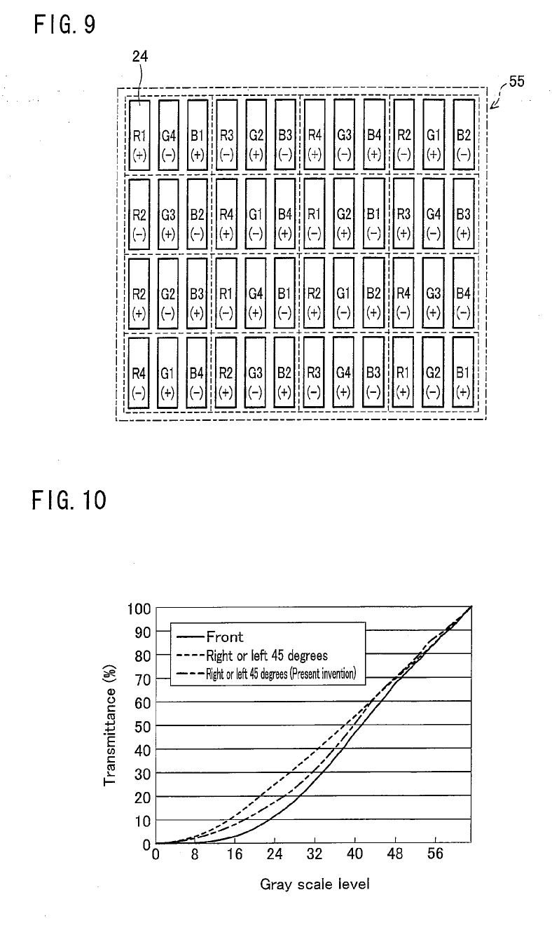

FIG. 9 illustrates how a unit 55 is configured in a case where the display is carried out in the present embodiment. Note here that, each of pixels (i.e., regions surrounded by dotted lines in FIG. 9) is defined as including a red (R) dot 24, a green (G) dot 24, and a blue (B) dot 24. According to the present embodiment, the unit 55 includes sixteen pixels of (four pixels×four pixels (see FIG. 9).

According to the present embodiment, the area-division driving is carried out with respect to each unit. That is, the display controller 114 (display drive section) carries out a data conversion process so that a piece of input gray scale data (a piece of R data, a piece of G data, a piece of B data) is converted into pieces of gray scale data which differ from location to location and are then supplied to the respective dots 24 in the unit 55 which is defined as including sixteen pixels (four pixels×four pixels). When the pieces of the gray scale data are displayed in the dots 24 in the unit 55, an average of the pieces of the gray scale data allows a gray scale display (i.e., a target gray scale display) to be achieved in the entire unit 55 in accordance with the piece of the input gray scale data.

In addition to the area-division driving, the present embodiment further employs the time-division driving so as to suppress a deterioration in resolution which reduction may occur as a result of the area-division driving. According to the time-division driving, a unit cycle period is defined as including a plurality of successive frames; and data written into each of the dots is changed each frame. That is, the display controller 114 carries out a data conversion process such that: a unit cycle period is defined as including a plurality of frame periods; and a time-average of pieces of gray scale data to be displayed during the respective plurality of frames serves as a piece of gray scale data to be displayed during the unit cycle period.

The following description discusses how the data conversion is carried out by the display controller 114.

As illustrated in FIG. 8, the display controller 114 receives, from the signal source (not illustrated), the piece of the input gray scale data (pieces of input gray scale data [R, G, and B data], the input sync signals [vertical sync signals and horizontal sync signals], and the dot clocks).

The location information detection section 131 of the display controller 114 detects location information that indicates which dot 24 in the unit 55 as shown in FIG. 9 receives a piece of the input gray scale data, in accordance with the piece of the input gray scale data, a corresponding one of the input sync signals (i.e., a horizontal sync signal), and a corresponding one of the dot clocks. Then, the location information detection section 131 outputs the location information thus detected.

The frame counter 132 counts the number of the input vertical sync signals (i.e., counts the number of frames), so as to find frame information indicating which frame corresponds to a piece of gray scale data corresponding to the vertical sync signal. Since the unit cycle is defined as including successive four frame periods according to the present embodiment, the frame counter 132 finds frame information indicating which frame period corresponds to a piece of gray scale data corresponding to the vertical sync signal. Then, the frame counter 132 outputs the frame information thus obtained.

The location information and the frame information are supplied to the input data conversion section 133. The input data conversion section 133 converts the piece of the input gray scale data on the basis of the piece of the input gray scale data, the location information corresponding to the piece of the input gray scale data, and the frame information corresponding to the piece of the input gray scale data. Specifically, the input data conversion section 133 converts the piece of the input gray scale data, on the basis of the location information and the frame information, into pieces of gray scale data which are supplied to the respective dots 24 in the unit 55 and which differ (i) from location to location in the unit 55 and (ii) from frame to frame in the unit cycle.

According to the present embodiment, the conversion of the gray scale data is carried out with reference to four different lookup tables 134a, 134b, 134c, and 134d. This makes it possible to carry out the conversion of the input gray scale data in four different ways.

That is, the input data conversion section 133 carries out the conversion of the input gray scale data in a way that differs (i) from location to location in the unit 55 and (ii) from frame to frame in the unit cycle by selecting, on the basis of the input location information and the input frame information, one of the four different lookup tables 134a through 134d.

The piece of the gray scale data thus converted is then supplied to the timing controller 135.

Processes after the timing controller 135 has received the converted gray scale data are same as those of Embodiment 1.

The following description discusses a more specific example of the data conversion process, which is employed in a case where (i) the unit 55 is configured as illustrated in FIG. 9 and (ii) it is intended to display, in the entire unit 55, a piece of gray scale data D (R, G, B).

In this case, the piece of the gray scale data D is converted into pieces of gray scale data of four different kinds, i.e., D1 (R1, G1, B1), D2 (R2, G2, B2), D3 (R3, G3, B3), and D4 (R4, G4, B4). Note here that the combination of the pieces of the gray scale data D1, D2, D3 and D4 is selected so that an average of them is equal to the piece of the gray scale data D in a case where the pieces of the gray scale data D1, D2, D3, and D4 are displayed in respective areas having an identical size for an identical period of time. For example, in a case of 6-bit gray scale data, a first lookup table 134a (LUT1) stores pieces of output gray scale data D1 for respective pieces of input gray scale data D (0 through 63), a second lookup table 134b (LUT2) stores pieces of output gray scale data D2 for the respective pieces of the input gray scale data D (0 through 63), a third lookup table 134c (LUT3) stores pieces of output gray scale data D3 for the respective pieces of the input gray scale data D (0 through 63), and a fourth lookup table 134d (LUT4) stores pieces of output gray scale data D4 for the respective pieces of the input gray scale data D (0 through 63).

The input data conversion section 133 (i) selects, on the basis of the location information detected by the location information detection section 131 and the frame information counted by the frame counter 132, one of the D1 through D4 to be displayed, during a specific frame period, in each of the dots 24 of the unit 55 and then (ii) determines pieces of gray scale data, as respective converted ones, received from a selected one of the LUTs.

FIG. 9 illustrates one example of pieces of gray scale data, which have been subjected to the data conversion process, obtained during a certain frame period. As is clear from FIG. 9, a display ratio (area ratio) of the D1 (R1, G1, B1), the D2 (R2, G2, B2), the D3 (R3, G3, B3), and the D4 (R4, G4, B4), i.e., (D1:D2:D3:D4) is equal to 1:1:1:1.

This causes mix of the D1 through D4 to be displayed during a certain frame period. Note, however, that the entire unit is perceived as having the piece of the gray scale data D, as a result of spatial averaging.

Further, the present embodiment employs the time-division driving. According to the time-division driving, one (1) unit cycle period includes four successive frame periods; and a piece of gray scale data D, obtained by averaging pieces of gray scale data to be displayed during the respective four successive frame periods, serves as a piece of gray scale data to be displayed during the unit cycle period.

The pieces of the gray scale data D1 through D4 are sequentially displayed frame by frame. That is, the piece of identical data is displayed every four frames. Therefore, each of the dots is perceived as having the piece of the gray scale data D, as a result of time-average.

This allows the entire unit to achieve a display that is uniform in terms of time and space, and therefore can prevent display unevenness and a deterioration in resolution.

FIG. 10 is a graph illustrating measurement results of a gray scale-luminance characteristic (how a gray scale level and transmittance are related) obtained when a drive method of the present embodiment is employed in an MVA liquid crystal display device. The graph of FIG. 10 illustrates, for comparison, also a result obtained when a conventional drive method is employed. In FIG. 10, (i) a solid line indicates a gray scale-luminance characteristic obtained when a liquid crystal display panel is viewed from a front direction (this characteristic is common to the method of the present embodiment and the conventional method), (ii) a dashed line indicates a gray scale-luminance characteristic obtained when the liquid crystal display device employs the drive method of the present embodiment and the liquid crystal display panel is viewed from a right or left oblique direction at an angle of 45 degrees to the liquid crystal display panel, and (iii) a dotted line indicates a gray scale-luminance characteristic obtained when the liquid crystal display device employs the conventional drive method and the liquid crystal display panel is viewed from a right or left oblique direction at an angle of 45 degrees to the liquid crystal display panel.

As is clear from the graph of FIG. 10, in a case where the drive method of the present embodiment is employed, it is possible to suppress a phenomenon of the luminance becoming high when viewed from an oblique direction (such a phenomenon is called excess brightness), as compared with the case where the conventional drive method is employed.

The “excess brightness rates” for the results illustrated in FIG. 10 are found in the same way as in Embodiment 1. The following “excess brightness rates” were obtained:

Drive method of present embodiment: Excess brightness rate=19.0%

Conventional drive method: Excess brightness rate=53.6%

These results show that the excess brightness rate was more reduced in the present embodiment than in Embodiment 1, and the excess brightness is suppressed at substantially all gray scale levels. Further, since a piece of data is divided into pieces of data of four kinds according to the present embodiment, the present embodiment allows for a variety of combinations of pieces of data. This makes it possible to provide more uniform image display.

As is the case with Embodiment 1, according to the present embodiment, (i) a G dot and (ii) R and B dots in each of the pixels are supplied with pieces of the gray scale data of different kinds during a certain frame period (see FIG. 9), for the purpose of suppressing image sticking and flicker during the dot reversal driving. The R and B dots are supplied with pieces of the gray scale data of the same kind.

Specifically, during each frame period, pieces of the gray scale data of the same kind are selected as the pieces of the gray scale data to be supplied to dots (e.g., R and B), whose polarities are identical, in each of the pixels, whereas pieces of the gray scale data of different kinds are selected as the pieces of the gray scale data to be supplied to dots (e.g., [i] R and [ii] B and G), whose polarities are different, in each of the pixels. In FIG. 9, polarities of the respective dots during a certain frame period are shown in parenthesis. This makes it possible to suppress image sticking and unevenness of pattern during the time-division driving.

### Embodiment 4

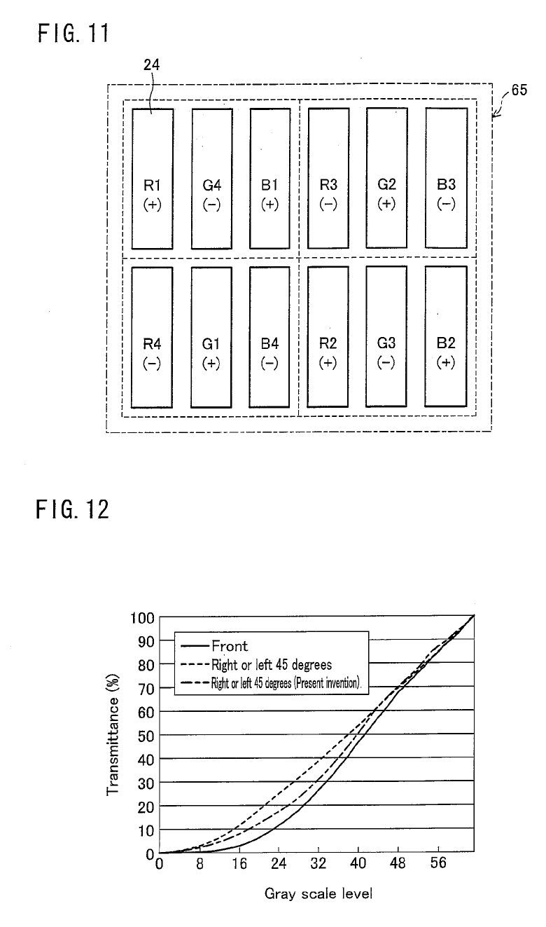

A fourth embodiment in accordance with the present invention is described below with reference to FIGS. 11 and 12.

As is the case with the foregoing embodiments, a liquid crystal display device of the present embodiment also employs both the area-division driving and the time-division driving so as to carry out a display. Therefore, a liquid crystal display device 110 of the present embodiment has a configuration identical to that of the liquid crystal display device of Embodiment 3 (see FIG. 8). The following description discusses only how a drive method of the present embodiment is different from the drive method of Embodiment 3.

FIG. 11 illustrates how a unit 65 is configured in a case where the display is carried out in the present embodiment. Note here that, each of pixels (i.e., regions surrounded by dotted lines in FIG. 11) is defined as including a red (R) dot 24, a green (G) dot 24, and a blue (B) dot 24. According to the present embodiment, one (1) unit 65 includes four pixels of (two pixels×two pixels) (see FIG. 11).

The following description discusses data conversion that is carried out in a case where (i) the unit 65 is configured as illustrated in FIG. 11 and (ii) it is intended to display, in the entire unit 65, a piece of gray scale data D (R, G, B).

In this case, according to the present embodiment, the piece of the gray scale data D is converted into pieces of gray scale data of four different kinds, i.e., D1 (R1, G1, B1), D2 (R2, G2, B2), D3 (R3, G3, B3), and D4 (R4, G4, B4). Note here that the combination of the pieces of the gray scale data D1 through D4 is selected so that an average of them is equal to the piece of the gray scale data D in a case where the pieces of the gray scale data D1 through D4 are displayed in respective areas having an identical size for an identical period of time. For example, in a case of 6-bit gray scale data, a first lookup table 134a (LUT1) stores pieces of output gray scale data D1 for respective pieces of input gray scale data D (0 through 63), a second lookup table 134b (LUT2) stores pieces of output gray scale data D2 for the respective pieces of the input gray scale data D (0 through 63), a third lookup table 134c (LUT3) stores pieces of output gray scale data D3 for the respective pieces of the input gray scale data D (0 through 63), and a fourth lookup table 134d (LUT4) stores pieces of output gray scale data D4 for the respective pieces of the input gray scale levels D (0 through 63).

The input data conversion section 133 (i) selects, on the basis of the location information detected by the location information detection section 131 and the frame information counted by the frame counter 132, one of the D1 through D4 to be displayed, during a specific frame period, in each of the dots 24 of the unit 65 and then (ii) determines pieces of gray scale data, as respective converted ones, received from a selected one of the LUTs.

FIG. 11 illustrates one example of pieces of gray scale data, which have been subjected to the data conversion process, obtained during a certain frame period. As is clear from FIG. 11, a display ratio (area ratio) of the D1 (R1, G1, B1), the D2 (R2, G2, B2), the D3 (R3, G3, B3), and the D4 (R4, G4, B4), i.e., (D1:D2:D3:D4) is 1:1:1:1.

This causes mix of the D1 through D4 to be displayed during a certain frame period. Note, however, that the entire unit is perceived as having the piece of the gray scale data D, as a result of spatial averaging.

Further, the present embodiment employs the time-division driving. According to the time-division driving, one (1) unit cycle period includes four successive frame periods; and a piece of gray scale data D, obtained by averaging pieces of gray scale data to be displayed during the respective four successive frame periods, serves as a piece of gray scale data to be displayed during the unit cycle period.

The pieces of the gray scale data D1 through D4 are sequentially displayed frame by frame. That is, the piece of identical data is displayed every four frames. Therefore, each of the dots is perceived as having the piece of the gray scale data D, as a result of time-average.

This allows the entire unit to achieve a display that is uniform in terms of time and space, and therefore can prevent display unevenness and a deterioration in resolution.

FIG. 12 is a graph illustrating measurement results of a gray scale-luminance characteristic (how a gray scale level and transmittance are related) obtained when a drive method of the present embodiment is employed in an MVA liquid crystal display device. The graph of FIG. 12 illustrates, for comparison, also a result obtained when a conventional drive method is employed. In FIG. 12, (i) a solid line indicates a gray scale-luminance characteristic obtained when a liquid crystal display panel is viewed from a front direction (this characteristic is common to the method of the present embodiment and the conventional method), (ii) a dashed line indicates a gray scale-luminance characteristic obtained when the liquid crystal display device employs the drive method of the present embodiment and the liquid crystal display panel is viewed from a right or left oblique direction at an angle of 45 degrees to the liquid crystal display panel, and (iii) a dotted line indicates a gray scale-luminance characteristic obtained when the liquid crystal display device employs the conventional drive method and the liquid crystal display panel is viewed from a right or left oblique direction at an angle of 45 degrees to the liquid crystal display panel.

As is clear from the graph of FIG. 12, in a case where the drive method of the present embodiment is employed, it is possible to suppress a phenomenon of the luminance becoming high when viewed from an oblique direction (such a phenomenon is called excess brightness), as compared with the case where the conventional drive method is employed.

The “excess brightness rates” for the results illustrated in FIG. 12 are found in the same way as in Embodiment 1. The following “excess brightness rates” were obtained:

Drive method of present embodiment: Excess brightness rate=19.0%

Conventional drive method: Excess brightness rate=53.6%

These results show that the present embodiment gives an effect equivalent to that of Embodiment 3. Further, since a piece of gray scale data is divided into pieces of the gray scale data of four kinds according to the present embodiment, the present embodiment allows for a variety of combinations of pieces of gray scale data. In addition, since the unit of the present embodiment includes fewer dots than that of Embodiment 3, it is possible to carry out a more uniform display.

As is the case with Embodiment 1, according to the present embodiment, (i) a G dot and (ii) R and B dots in each of the pixels are supplied with pieces of the gray scale data of different kinds during a certain frame period (see FIG. 11), for the purpose of suppressing image sticking and flicker during the dot reversal driving. The R and B dots are supplied with pieces of the gray scale data of the same kind.

Specifically, during each frame period, pieces of the gray scale data of the same kind are selected as the pieces of the gray scale data to be supplied to dots (e.g., R and B), whose polarities are identical, in each of the pixels, whereas pieces of the gray scale data of different kinds are selected as the pieces of the gray scale data to be supplied to dots (e.g., [i] R and [ii] B and G), whose polarities are different, in each of the pixels. In FIG. 11, polarities of the respective dots during a certain frame period are shown in parenthesis. This makes it possible to suppress image sticking and unevenness of each pattern during the time-division driving.

### Embodiment 5

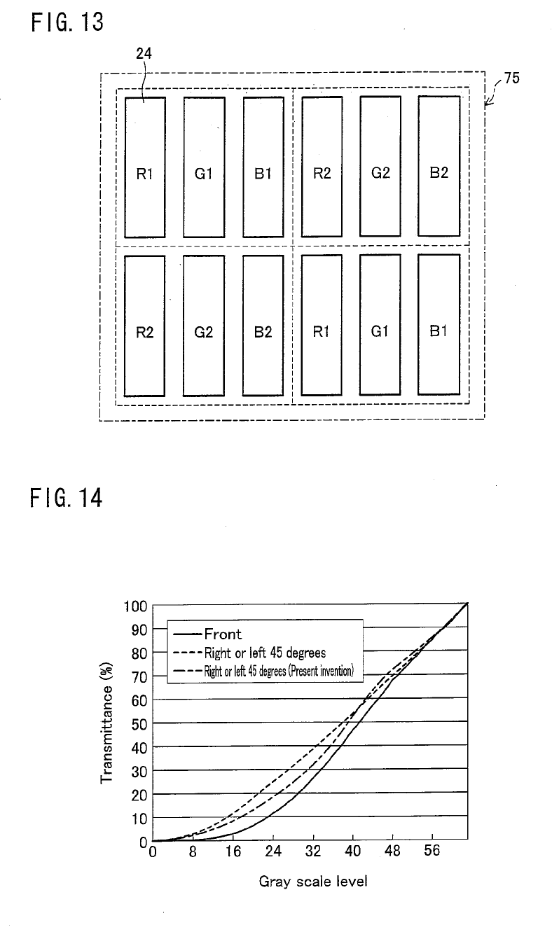

A fifth embodiment in accordance with the present invention is described below with reference to FIGS. 13 and 14.

As is the case with Embodiment 1, a liquid crystal display device of the present embodiment also employs both the area-division driving and the time-division driving so as to carry out a display. Therefore, a liquid crystal display device 10 of the present embodiment has a configuration identical to that of the liquid crystal display device of Embodiment 1 (see FIG. 1). The following description discusses only how the present embodiment is different from Embodiment 1.

FIG. 13 illustrates how a unit 75 is configured in a case where the display is carried out in the present embodiment. Note here that, each of pixels (i.e., regions surrounded by dotted lines in FIG. 13) is defined as including a red (R) dot 24, a green (G) dot 24, and a blue (B) dot 24. According to the present embodiment, one (1) unit 75 includes four pixels of (two pixels×two pixels) (see FIG. 13).

The following description discusses data conversion that is carried out in a case where (i) the unit 75 is configured as illustrated in FIG. 13 and (ii) it is intended to display, in the entire unit 75, a piece of gray scale data D (R, G, B).

The data conversion process of the present embodiment is substantially same as that of Embodiment 1. Note however that, while (i) the G dot and (ii) the R and B dots in each of the pixels are supplied with pieces of the gray scale data of different kinds during a certain frame period (see FIG. 3) according to Embodiment 1, all the dots (R dot, G dot, and B dot) in each of the pixels are supplied with pieces of the gray scale data of the same kind during the certain frame period according to the present embodiment (see FIG. 13).

As is the case with Embodiment 1, according to the present embodiment, the display ratio (area ratio) of the D1 (R1, G1, B1) to the D2 (R2, G2, B2), i.e., (D1:D2) is equal to 1:1.

This causes mix of the D1 and D2 to be displayed during a certain frame period. Note, however, that the entire unit is perceived as having the piece of the gray scale data D, as a result of spatial averaging.

Further, the present embodiment employs the time-division driving. According to the time-division driving, one (1) unit cycle period includes two successive frame periods, i.e., (i) a first half (a first frame period) during which a piece of gray scale data D1 is displayed and (ii) a second half (a second frame period) during which a piece of gray scale data D2 is displayed; and a piece of gray scale data D, obtained by averaging the piece of the gray scale data D1 and the piece of the gray scale data D2, serves as a piece of gray scale data to be displayed during the unit cycle period. FIG. 13 illustrates one example of pieces of gray scale data, which have been subjected to the data conversion process, obtained during a certain frame period.

The piece of the gray scale data D1 and the piece of the gray scale data D2 are displayed alternately every other frame. That is, the piece of identical data is displayed every two frames. Therefore, each of the dots is perceived as having the piece of the gray scale data D, as a result of time-average.

This allows the entire unit to achieve a display that is uniform in terms of time and space, and therefore can prevent display unevenness and a deterioration in resolution.

FIG. 14 is a graph illustrating measurement results of a gray scale-luminance characteristic (how a gray scale level and transmittance are related) obtained when a drive method of the present embodiment is employed in an MVA liquid crystal display device. The graph of FIG. 14 illustrates, for comparison, also a result obtained when a conventional drive method is employed. In FIG. 14, (i) a solid line indicates a gray scale-luminance characteristic obtained when a liquid crystal display panel is viewed from a front direction (this characteristic is common to the method of the present embodiment and the conventional method), (ii) a dashed line indicates a gray scale-luminance characteristic obtained when the liquid crystal display device employs the drive method of the present embodiment and the liquid crystal display panel is viewed from a right or left oblique direction at an angle of 45 degrees to the liquid crystal display panel, and (iii) a dotted line indicates a gray scale-luminance characteristic obtained when the liquid crystal display device employs the conventional drive method and the liquid crystal display panel is viewed from the right or left oblique direction at the angle of 45 degrees to the liquid crystal display panel.

As is clear from the graph of FIG. 14, in a case where the drive method of the present embodiment is employed, it is possible to suppress a phenomenon of the luminance becoming high when viewed from an oblique direction (such a phenomenon is called excess brightness), as compared with the case where the conventional drive method is employed.

The “excess brightness rates” for the results illustrated in FIG. 14 are found in the same way as in Embodiment 1. The following “excess brightness rates” were obtained:

Drive method of present embodiment: Excess brightness rate=25.6%

Conventional drive method: Excess brightness rate=53.6%

These results show that the excess brightness can be suppressed to a degree similar to that of Embodiment 1.

### Embodiment 6

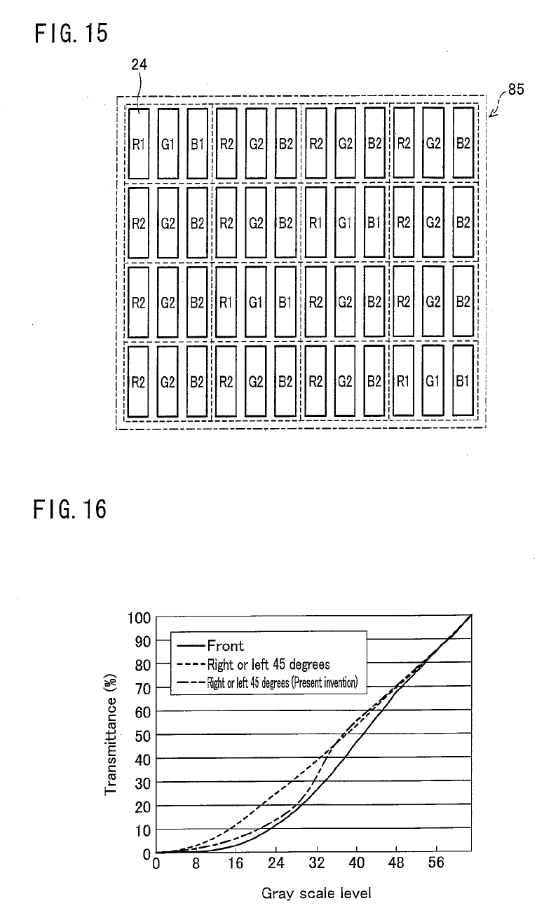

A sixth embodiment in accordance with the present invention is described below with reference to FIGS. 15 and 16.

As is the case with Embodiment 1, a liquid crystal display device of the present embodiment also employs both the area-division driving and the time-division driving so as to carry out a display. Therefore, a liquid crystal display device 10 of the present embodiment has a configuration identical to that of the liquid crystal display device of Embodiment 1 (see FIG. 1). Further, since the present embodiment employs a drive method similar to that employed in Embodiment 2, the following description discusses only how the present embodiment is different from Embodiment 2.

FIG. 15 illustrates how a unit 85 is configured in a case where the display is carried out in the present embodiment. Note here that, each of pixels (i.e., regions surrounded by dotted lines in FIG. 15) is defined as including a red (R) dot 24, a green (G) dot 24, and a blue (B) dot 24. According to the present embodiment, one (1) unit 85 includes sixteen pixels of (four pixels×four pixels) (see FIG. 15).

The following description discusses data conversion that is carried out in a case where (i) the unit 85 is configured as illustrated in FIG. 15 and (ii) it is intended to display, in the entire unit 85, a piece of gray scale data D (R, G, B).

The data conversion process of the present embodiment is substantially same as that of Embodiment 2. Note however that, while (i) the G dot and (ii) the R and B dots in each of some of the pixels in the unit 45 are supplied with pieces of the gray scale data of different kinds during a certain frame period (see FIG. 6) according to Embodiment 2, all the dots (R dot, G dot, and B dot) in each of the pixels are supplied with pieces of the gray scale data of the same kind during the certain frame period according to the present embodiment (see FIG. 15).

As is the case with Embodiment 2, according to the present embodiment, the display ratio (area ratio) of the D1 (R1, G1, B1) to the D2 (R2, G2, B2), i.e., (D1:D2) is equal to 1:3.

This causes mix of the D1 and D2 to be displayed during a certain frame period. Note, however, that the entire unit is perceived as having the piece of the gray scale data D, as a result of spatial averaging.

Further, the present embodiment employs the time-division driving. According to the time-division driving, one unit cycle period includes four successive frame periods; and a piece of gray scale data D, obtained by averaging pieces of gray scale data to be displayed during the respective four successive frame periods, serves as a piece of gray scale data to be displayed during the unit cycle period. FIG. 15 illustrates one example of pieces of gray scale data, which have been subjected to the data conversion process, obtained during a certain frame period.

The piece of the gray scale data D1 and the piece of the gray scale data D2 are displayed alternately every other frame. That is, the piece of identical data is displayed every four frames. Therefore, each of the dots is perceived as having the piece of the gray scale data D, as a result of time-average.

This allows the entire unit to achieve a display that is uniform in terms of time and space, and therefore can prevent display unevenness and a deterioration in resolution.

FIG. 16 is a graph illustrating measurement results of a gray scale-luminance characteristic (how a gray scale level and transmittance are related) obtained when a drive method of the present embodiment is employed in an MVA liquid crystal display device. The graph of FIG. 16 illustrates, for comparison, also a result obtained when a conventional drive method is employed. In FIG. 16, (i) a solid line indicates a gray scale-luminance characteristic obtained when a liquid crystal display panel is viewed from a front direction (this characteristic is common to the method of the present embodiment and the conventional method), (ii) a dashed line indicates a gray scale-luminance characteristic obtained when the liquid crystal display device employs the drive method of the present embodiment and the liquid crystal display panel is viewed from a right or left oblique direction at an angle of 45 degrees to the liquid crystal display panel, and (iii) a dotted line indicates a gray scale-luminance characteristic obtained when the liquid crystal display device employs the conventional drive method and the liquid crystal display panel is viewed from the right or left oblique direction at the angle of 45 degrees to the liquid crystal display panel.

As is clear from the graph of FIG. 16, in a case where the drive method of the present embodiment is employed, it is possible to suppress a phenomenon of the luminance becoming high when viewed from an oblique direction (such a phenomenon is called excess brightness), as compared with the case where the conventional drive method is employed.

The “excess brightness rates” for the results illustrated in FIG. 16 are found in the same way as in Embodiment 1. The following “excess brightness rates” were obtained:

Drive method of present embodiment: Excess brightness rate=14.7%

Conventional drive method: Excess brightness rate=53.6%

These results show that the excess brightness can be suppressed to a degree similar to that of Embodiment 2.

### Embodiment 7

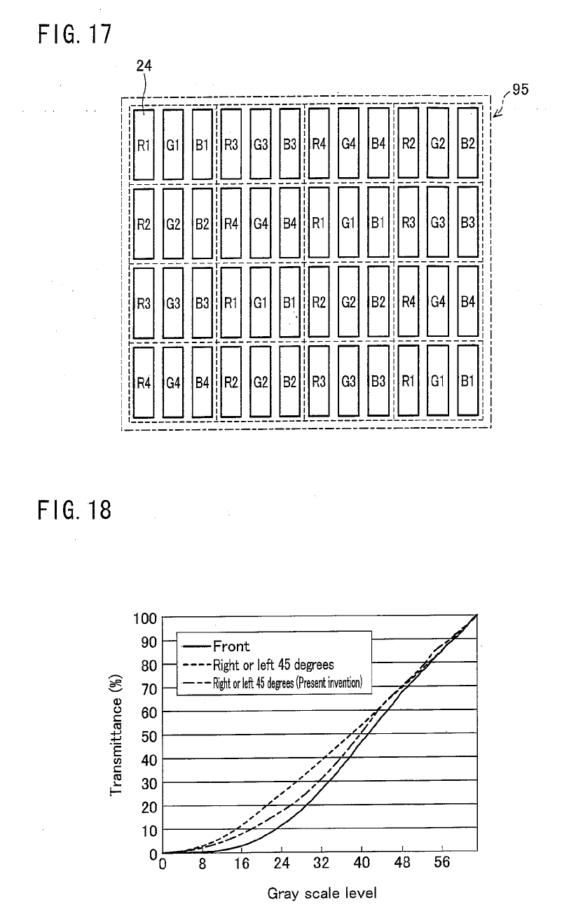

A seventh embodiment in accordance with the present invention is described below with reference to FIGS. 17 and 18. A liquid crystal display device 110 of the present embodiment has a configuration identical to that of the liquid crystal display device of Embodiment 3 (see FIG. 8), and a drive method of the present embodiment is similar to that employed in Embodiment 3. Therefore, the following description discusses only how the present embodiment is different from Embodiment 3.

FIG. 17 illustrates how a unit 95 is configured in a case where a display is carried out in the present embodiment. Note here that, each of pixels (i.e., regions surrounded by dotted lines in FIG. 17) is defined as including a red (R) dot 24, a green (G) dot 24, and a blue (B) dot 24. According to the present embodiment, one (1) unit 95 includes sixteen pixels of (four pixels×four pixels) (see FIG. 17).

The following description discusses data conversion that is carried out in a case where (i) the unit 95 is configured as illustrated in FIG. 17 and (i) it is intended to display, in the entire unit 95, a piece of gray scale data D (R, G, B).

The data conversion process of the present embodiment is substantially same as that of Embodiment 3. Note however that, while (i) the G dot and (ii) the R and B dots in each of the pixels are supplied with pieces of the gray scale data of different kinds during a certain frame period (see FIG. 9) according to Embodiment 1, all the dots (R dot, G dot, and B dot) in each of the pixels are supplied with pieces of the gray scale data of the same kind during the certain frame period according to the present embodiment (see FIG. 17).

As is the case with Embodiment 3, according to the present embodiment, the display ratio (area ratio) of the D1 (R1, G1, B1), D2 (R2, G2, B2), D3 (R3, G3, B3), and D4 (R4, G4, B4), i.e., (D1:D2:D3:D4) is equal to 1:1:1:1.

This causes mix of the D1 through D4 to be displayed during a certain frame period. Note, however, that the entire unit is perceived as having the piece of the gray scale data D, as a result of spatial averaging.

Further, the present embodiment employs the time-division driving. According to the time-division driving, one (1) unit cycle period includes four successive frame periods; and a piece of gray scale data D, obtained by averaging pieces of gray scale data to be displayed during the respective four successive frame periods, serves as a piece of gray scale data to be displayed during the unit cycle period. FIG. 17 illustrates one example of pieces of gray scale data, which have been subjected to the data conversion process, obtained during a certain frame period.

The gray scale data D1 through D4 are sequentially displayed frame by frame. That is, the piece of identical data is displayed every four frames. Therefore, each of the dots is perceived as having the piece of the gray scale data D, as a result of time-average.

This allows the entire unit to achieve a display that is uniform in terms of time and space, and therefore can prevent display unevenness and a deterioration in resolution.

FIG. 18 is a graph illustrating measurement results of a gray scale-luminance characteristic (how a gray scale level and transmittance are related) obtained when a drive method of the present embodiment is employed in an MVA liquid crystal display device. The graph of FIG. 18 illustrates, for comparison, also a result obtained when a conventional drive method is employed. In FIG. 18, (i) a solid line indicates a gray scale-luminance characteristic obtained when a liquid crystal display panel is viewed from a front direction (this characteristic is common to the method of the present embodiment and the conventional method), (ii) a dashed line indicates a gray scale-luminance characteristic obtained when the liquid crystal display device employs the drive method of the present embodiment and the liquid crystal display panel is viewed from a right or left oblique direction at an angle of 45 degrees to the liquid crystal display panel, and (iii) a dotted line indicates a gray scale-luminance characteristic obtained when the liquid crystal display device employs the conventional drive method and the liquid crystal display panel is viewed from a right or left oblique direction at an angle of 45 degrees to the liquid crystal display panel.

As is clear from the graph of FIG. 18, in a case where the drive method of the present embodiment is employed, it is possible to suppress a phenomenon of the luminance becoming high when viewed from an oblique direction (such a phenomenon is called excess brightness), as compared with the case where the conventional drive method is employed.

The “excess brightness rates” for the results illustrated in FIG. 18 are found in the same way as in Embodiment 1. The following “excess brightness rates” were obtained:

Drive method of present embodiment: Excess brightness rate=19.0%

Conventional drive method: Excess brightness rate=53.6%

These results show that the excess brightness can be suppressed to a degree similar to that of Embodiment 3.

### Embodiment 8

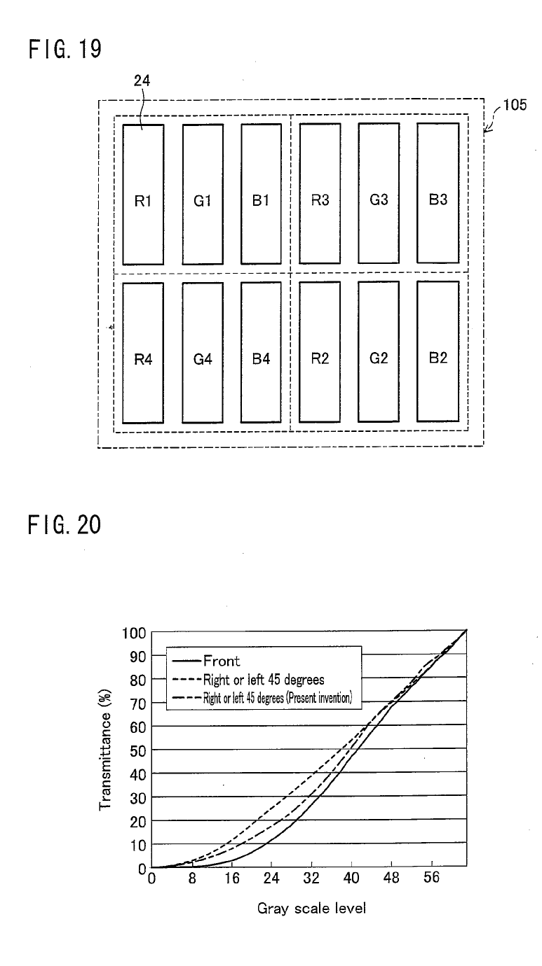

An eighth embodiment in accordance with the present invention is described below with reference to FIGS. 19 and 20. A liquid crystal display device 110 of the present embodiment has a configuration identical to that of the liquid crystal display device of Embodiment 3 (see FIG. 8), and a drive method of the present embodiment is similar to that employed in Embodiment 4. Therefore, the following description discusses only how the present embodiment is different from Embodiment 4.

FIG. 19 illustrates how a unit 105 is configured in a case where a display is carried out in the present embodiment. Note here that, each of pixels (i.e., regions surrounded by dotted lines in FIG. 19) is defined as including a red (R) dot 24, a green (G) dot 24, and a blue (B) dot 24. According to the present embodiment, one (1) unit 105 includes four pixels of (two pixels×two pixels) (see FIG. 19).

The following description discusses data conversion that is carried out in a case where (i) the unit 105 is configured as illustrated in FIG. 19 and (i) it is intended to display, in the entire unit 105, a piece of gray scale data D (R, G, B).

The data conversion process of the present embodiment is substantially same as that of Embodiment 4. Note however that, while (i) the G dot and (ii) the R and B dots in each of the pixels are supplied with pieces of the gray scale data of different kinds during a certain frame period (see FIG. 11) according to Embodiment 4, all the dots (R dot, G dot, and B dot) in each of the pixels are supplied with pieces of the gray scale data of the same kind during the certain frame period according to the present embodiment (see FIG. 19).

As is the case with Embodiment 4, according to the present embodiment, the display ratio (area ratio) of the D1 (R1, G1, B1), D2 (R2, G2, B2), D3 (R3, G3, B3), and D4 (R4, G4, B4), i.e., (D1:D2:D3:D4) is equal to is 1:1:1:1.

This causes mix of the D1 through D4 to be displayed during a certain frame period. Note, however, that the entire unit is perceived as having the piece of the gray scale data D, as a result of spatial averaging.

Further, the present embodiment employs the time-division driving. According to the time-division driving, one (1) unit cycle period includes four successive frame periods; and a piece of gray scale data D, obtained by averaging pieces of gray scale data to be displayed during the respective four successive frame periods, serves as a piece of gray scale data to be displayed during the unit cycle period. FIG. 19 illustrates one example of pieces of gray scale data, which have been subjected to the data conversion process, obtained during a certain frame period.

The gray scale data D1 through D4 are sequentially displayed frame by frame. That is, the piece of identical data is displayed every four frames. Therefore, each of the dots is perceived as having the piece of the gray scale data D, as a result of time-average.

This allows the entire unit to achieve a display that is uniform in terms of time and space, and therefore can prevent display unevenness and a deterioration in resolution.

FIG. 20 is a graph illustrating measurement results of a gray scale-luminance characteristic (how a gray scale level and transmittance are related) obtained when a drive method of the present embodiment is employed in an MVA liquid crystal display device. The graph of FIG. 20 illustrates, for comparison, also a result obtained when a conventional drive method is employed. In FIG. 20, (i) a solid line indicates a gray scale-luminance characteristic obtained when a liquid crystal display panel is viewed from a front direction (this characteristic is common to the method of the present embodiment and the conventional method), (ii) a dashed line indicates a gray scale-luminance characteristic obtained when the liquid crystal display device employs the drive method of the present embodiment and the liquid crystal display panel is viewed from a right or left oblique direction at an angle of 45 degrees to the liquid crystal display panel, and (iii) a dotted line indicates a gray scale-luminance characteristic obtained when the liquid crystal display device employs the conventional drive method and the liquid crystal display panel is viewed from a right or left oblique direction at an angle of 45 degrees to the liquid crystal display panel.

As is clear from the graph of FIG. 20, in a case where the drive method of the present embodiment is employed, it is possible to suppress a phenomenon of the luminance becoming high when viewed from an oblique direction (such a phenomenon is called excess brightness), as compared with the case where the conventional drive method is employed.

The “excess brightness rates” for the results illustrated in FIG. 20 are found in the same way as in Embodiment 1. The following “excess brightness rates” were obtained:

Drive method of present embodiment: Excess brightness rate=19.0%

Conventional drive method: Excess brightness rate=53.6%

These results show that the excess brightness can be suppressed to a degree similar to that of Embodiment 4.

The invention is not limited to the description of the embodiments above, but may be altered within the scope of the claims. An embodiment based on a proper combination of technical means altered within the scope of the claims, and an embodiment based on a proper combination of configurations disclosed in different embodiments are encompassed in the technical scope of the invention.

It should be noted that, although each of the aforementioned embodiments employs (i) a unit including four pixels (two pixels×two pixels) or (ii) a unit including sixteen pixels (four pixels×four pixels), the present invention is not limited to those described in the embodiments.

Further, although each of the aforementioned embodiments employs two lookup tables or four lookup tables, the present invention is not limited to those described in the embodiments. For example, it is possible to employ three lookup tables, and to refer to the lookup tables in order of LUT1, LUT2, LUT3, and LUT2 over a four-frame cycle.

The embodiments discussed in the foregoing description of embodiments and concrete examples serve solely to illustrate the technical details of the present invention, which should not be narrowly interpreted within the limits of such embodiments and concrete examples, but rather may be applied in many variations within the spirit of the present invention, provided such variations do not exceed the scope of the patent claims set forth below.

### INDUSTRIAL APPLICABILITY

The present invention makes it possible to reduce a difference between a gamma characteristic obtained when a liquid crystal display panel is viewed from a front direction and a gamma characteristic obtained when the liquid crystal display panel is viewed from an oblique direction, without making dot structures complicated, thereby further improving display quality. Accordingly, a liquid crystal display device in accordance with the present invention can be suitably used as a portable liquid crystal display device that includes a relatively small liquid crystal display panel.

### REFERENCE SIGNS LIST

10 Liquid crystal display device
11 Liquid crystal display panel
12 Gate driver
13 Source driver
14 Display controller (display drive section)
21 Scanning signal line
22 Data signal line
23 TFT
24 Dot
31 Location information detection section
32 Frame counter
33 Input data conversion section (Gray scale data conversion section)
34a First lookup table (lookup table)
34b Second lookup table (Lookup table)
35 Timing controller
25, 45, 55, 65, 75, 85, 95, 105 Unit
110 Liquid crystal display device
111 Liquid crystal display panel
112 Gate driver
113 Source driver
114 Display controller (Display drive section)
131 Location information detection section
132 Frame counter
133 Input data conversion section (Gray scale data conversion section)
134a First lookup table (Lookup table)
134b Second lookup table (Lookup table)
134c Third lookup table (Lookup table)
134d Fourth lookup table (Lookup table)
135 Timing controller

1. A method for driving a liquid crystal display device,
the liquid crystal display device including a liquid crystal display panel that includes:
a plurality of data signal lines;
a plurality of scanning signal lines intersecting the plurality of data signal lines; and
dots which are provided, in a matrix manner, for intersections of the plurality of data signal lines and the plurality of scanning signal lines,
said method, comprising the steps of:
(a) dividing the dots into a plurality of units each of which includes a predetermined number of dots; and
(b) supplying pieces of gray scale data, into which a piece of input gray scale data is converted and which differ from location to location, to the respective dots in each of the plurality of units so that a target gray scale display is carried out in said each of the plurality of units.

2. The method according to claim 1, wherein the step (b) includes the steps of:
(c) detecting location information, indicating which dot receives the piece of input gray scale data, in accordance with the piece of input gray scale data and an input sync signal that corresponds to the piece of input gray scale data; and
(d) causing the piece of input gray scale data to be converted into the pieces of gray scale data so as to (i) differ from location to location in accordance with the location information and then (ii) supply the pieces of gray scale data to the respective dots.

3. The method according to claim 2, further comprising the step of:
(e) carrying out a time-division driving in which an average of pieces of gray scale data, which are displayed during entire frame periods of a unit cycle which corresponds to a plurality of successive frames, serves as display gray scale data of the unit cycle.

4. The method according to claim 2, wherein, in the step (d),
the piece of input gray scale data is converted with reference to one of a plurality of lookup tables; and
said one of the plurality of lookup tables is selected in accordance with the location information.

5. The method according to claim 3, wherein, in the step (d),
the piece of input gray scale data is converted with reference to one of a plurality of lookup tables; and
said one of the plurality of lookup tables is selected in accordance with (i) the location information and (ii) frame information indicating which frame of the unit cycle corresponds to the piece of input gray scale data.

6. The method according to claim 4, wherein the number of the plurality of lookup tables is 2, 3, or 4.

7. The method according to claim 1, wherein, in a case where (i) the liquid crystal display device includes a red color filter, a green color filter, and a blue color filter and (ii) each pixel includes a corresponding red dot, a corresponding green dot, and a corresponding blue dot of the dots,
each of the plurality of units includes (a) four pixels of (two pixels×two pixels) or (b) sixteen pixels of (four pixels×four pixels).

8. The method according to claim 3, wherein the number of the plurality of successive frames in said each unit cycle is 2 or 4.

9. The method according to claim 3, wherein, in a case where (i) a signal voltage applied to each of the plurality of data signal lines is dot-inversion driven, (ii) the liquid crystal display device includes a red color filter, a green color filter, and a blue color filter, and (iii) each pixel includes a corresponding red dot, a corresponding green dot, and a corresponding blue dot of the dots,
in the step (d), pieces of gray scale data which are supplied to the respective dots of the each pixel during one of the plurality of successive frames of the unit cycle, to which dots the signal voltages having an identical polarity are applied, are subjected to an identical way of converting.

10. A liquid crystal display device, comprising: a liquid crystal display panel that includes:
a plurality of data signal lines;
a plurality of scanning signal lines intersecting the plurality of data signal lines; and
dots which are provided, in a matrix manner, for intersections of the plurality of data signal lines and the plurality of scanning signal lines,
said liquid crystal display device, further comprising:
a display drive section for (a) dividing the dots into a plurality of units each of which includes a predetermined number of dots and (b) supplying pieces of gray scale data, into which a piece of input gray scale data is converted and which differ from location to location, to the respective dots in each of the plurality of units so that a gray scale display obtained when the entire each of the plurality of units is viewed becomes a target gray scale display.

11. The liquid crystal display device according to claim 10, wherein the display drive section includes:
(c) location information detection section which detects location information indicating which dot receives the piece of input gray scale data, in accordance with the piece of input gray scale data and an input sync signal that corresponds to the piece of input gray scale data; and
(d) a gray scale data conversion section which causes the piece of input gray scale data to be converted into the pieces of gray scale data so as to (i) differ from location to location in accordance with the location information and then (ii) supply the pieces of gray scale data to the respective dots.

12. The liquid crystal display device according to claim 11, wherein the display drive section further carries out a time-division driving in which an average of pieces of gray scale data, which are displayed during entire frame periods of a unit cycle which corresponds to a plurality of successive frames, serves as display gray scale data of the unit cycle.

13. The liquid crystal display device according to claim 11, wherein:
the gray scale data conversion section selects one of a plurality of lookup tables in accordance with the location information, and converts the piece of input gray scale data with reference to said one of the plurality of lookup tables.

14. The liquid crystal display device according to claim 12, wherein:
the gray scale data conversion section (i) selects one of a plurality of lookup tables in accordance with (a) the location information and (b) frame information indicating which frame of the unit cycle corresponds to the piece of input gray scale data, and (ii) converts the piece of input gray scale data with reference to said one of the plurality of lookup tables.

15. The liquid crystal display device according to claim 13, wherein the number of the plurality of lookup tables is 2, 3, or 4.

16. The liquid crystal display device according to claim 10, wherein, in a case where (i) the liquid crystal display device includes a red color filter, a green color filter, and a blue color filter and (ii) each pixel includes a corresponding red dot, a corresponding green dot, and a corresponding blue dot of the dots,
each of the plurality of units includes (a) four pixels of (two pixels×two pixels) or (b) sixteen pixels of (four pixels×four pixels).

17. The liquid crystal display device according to claim 12, wherein the number of the plurality of successive frames in said each unit cycle is 2 or 4.

18. The liquid crystal display device according to claim 12, wherein, in a case where (i) a signal voltage applied to each of the plurality of data signal lines is dot-inversion driven, (ii) the liquid crystal display device includes a red color filter, a green color filter, and a blue color filter, and (iii) each pixel includes a corresponding red dot, a corresponding green dot, and a corresponding blue dot of the dots,
in the gray scale data conversion section, pieces of gray scale data which are supplied to the respective dots of the each pixel during one of the plurality of successive frames of the unit cycle, to which dots the signal voltages having an identical polarity are applied, are subjected to an identical way of converting.

19. The liquid crystal display device according to claim 10, wherein the liquid crystal display panel is a normally black liquid crystal display panel.

20. The method according to claim 5, wherein the number of the plurality of lookup tables is 2, 3, or 4.

21. The method according to claim 5, wherein the number of the plurality of successive frames in said each unit cycle is 2 or 4.

22. The liquid crystal display device according to claim 14, wherein the number of the plurality of lookup tables is 2, 3, or 4.

23. The liquid crystal display device according to claim 14, wherein the number of the plurality of successive frames in said each unit cycle is 2 or 4.
